(19) United States
(12) Patent Application Publication
(10) Pub. No.: US 2019/0135954 A1
(43) Pub. Date: May 9, 2019

(54) CATALYTIC COMPOSITIONS

(71) Applicant: SCG CHEMICALS CO., LTD., Bangkok (TH)

(72) Inventors: Dermot O'HARE, Oxford (GB); Jean-Charles BUFFET, Oxford (GB); Tossapol KHAMNAEN, Bangsue, Bangkok (TH); Manutsavin CHARERNSUK, Bangsue, Bangkok (TH); Thawesak PARAWAN, Bangsue, Bangkok (TH)

(21) Appl. No.: 16/309,706

(22) PCT Filed: Jun. 14, 2017
(86) PCT No.: PCT/GB2017/051726

§ 371 Date: Dec. 13, 2018

(30) Foreign Application Priority Data
Jun. 15, 2016 (GB) 1610464.8

(51) Int. Cl. C08F 10/02

(52) U.S. Cl. CPC C08F 10/02; C08F 2420/02

(57) ABSTRACT

Catalytic compositions comprising constrained geometry compounds associated with solid polymethylaluminoxane are disclosed. The compositions are useful as catalysts in the polymerisation and copolymerisation of alkanes

### INTRODUCTION

The present invention relates to catalytic compositions. More particularly, the present invention relates to catalytic compositions comprising constrained geometry complexes associated with a catalytic support material. The present invention also relates to the use of catalytic compositions in the polymerisation of alkenes.

### BACKGROUND OF THE INVENTION

It is well known that ethylene (and α-olefins in general) can be readily polymerized at low or medium pressures in the presence of certain transition metal catalysts. These catalysts are generally known as Zeigler-Natta type catalysts.

A particular group of these Ziegler-Natta type catalysts, which catalyse the polymerization of ethylene (and α-olefins in general), comprise an aluminoxane activator and a metallocene transition metal catalyst. Metallocenes comprise a metal bound between two η⁵-cyclopentadienyl type ligands. Generally the η⁵-cyclopentadienyl type ligands are selected from η⁵-cyclopentadienyl, η⁵-indenyl and η⁵-fluorenyl.

At the time of their conception, constrained geometry complexes (CGCs) represented one of the first major departures from metallocene-based catalysts. In structural terms, CGCs feature a π-bonded ligand linked to one of the other ligands on the same metal centre, in such a manner that the angle subtended by the centroid of the π-system and the other ligand from the metal centre is smaller than in comparable complexes wherein the π-bonded ligand and the other ligand are not linked. To date, research in the field of CGCs has centred around ansa-bridged cyclopentadienyl amido complexes, with such catalysts presently featuring heavily in the industrial preparation of CGC-derived polymers.

In spite of the advances made using ansa-bridged cyclopentadienyl amido-based complexes, there remains a need for CGCs, or compositions comprising them, having improved characteristics. In particular, there remains a need for CGCs having improved catalytic properties and/or GCGs suitable for preparing polymers having desirable characteristics. Such improved catalytic properties may include enhanced catalytic activity, better co-monomer incorporation and improved stability. Desirable polymer characteristics may include particular polymer molecular weights, polydispersities and melt indices.

The present invention was devised with the foregoing in mind.

### SUMMARY OF THE INVENTION

According to a first aspect of the present invention, there is provided a catalytic composition comprising a compound of formula (I) as defined herein associated with solid polymethylaluminoxane.

According to a further aspect of the present invention, there is provided a use of a composition as defined herein in the polymerisation of ethylene and optionally one or more (3-10C)alkene.

According to a further aspect of the present invention, there is provided a polymerisation process comprising the step of:
a) polymerising ethylene and optionally one or more (3-10C)alkene in the presence of a composition as defined herein.

### DETAILED DESCRIPTION OF THE INVENTION

### Definitions

The term “(m-nC)” or “(m-nC) group” used alone or as a prefix, refers to any group having m to n carbon atoms.

The term “alkyl” as used herein includes reference to a straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl (including neopentyl), hexyl and the like. In particular, an alkyl may have 1, 2, 3 or 4 carbon atoms.

The term “alkenyl” as used herein include reference to straight or branched chain alkenyl moieties, typically having 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “(3-10C)alkene” as used herein includes reference to any alkene having 3-10 carbon atoms that is capable of being copolymerised with ethylene. Straight and branching aliphatic alkenes are included (e.g. 1-hexene or 1-octene), as are alkenes comprising an aromatic moiety (e.g. styrene).

The term “alkynyl” as used herein include reference to straight or branched chain alkynyl moieties, typically having 2, 3, 4, 5 or 6 carbon atoms. The term includes reference to alkynyl moieties containing 1, 2 or 3 carbon-carbon triple bonds (C═C). This term includes reference to groups such as ethynyl, propynyl, butynyl, pentynyl and hexynyl.

The term “alkoxy” as used herein include reference to —O-alkyl, wherein alkyl is straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “aryl” as used herein includes reference to an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The term “aryl(m-nC)alkyl” means an aryl group covalently attached to a (m-nC)alkylene group. Examples of aryl-(m-nC)alkyl groups include benzyl, phenylethyl, and the like.

The term “halogen” or “halo” as used herein includes reference to F, Cl, Br or I. In a particular, halogen may be F or CI, of which CI is more common.

The term “substituted” as used herein in reference to a moiety means that one or more, especially up to 5, more especially 1, 2 or 3, of the hydrogen atoms in said moiety are replaced independently of each other by the corresponding number of the described substituents. The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible. For example, amino or hydroxy groups with free hydrogen may be unstable if bound to carbon atoms with unsaturated (e.g. olefinic) bonds. Additionally, it will of course be understood that the substituents described herein may themselves be substituted by any substituent, subject to the aforementioned restriction to appropriate substitutions as recognised by the skilled person.

### Compositions of the Invention

As described hereinbefore, the present invention provides a catalytic composition comprising a compound of formula (I) shown below associated with solid polymethylaluminoxane:

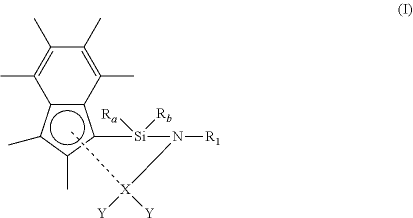

wherein

R₁ is (1-6C)alkyl, —Si(R₂)₃ or phenyl, either of which is optionally substituted with one or more groups selected from (1-4C)alkyl;
wherein each R₂ is independently selected from (1-3C)alkyl;

Rₐ and R_{b} are independently hydrogen, (1-6C)alkyl, aryl and aryl(1-2C)alkyl, either or which may be optionally substituted with one or groups selected from (1-2C)alkyl;

X is scandium, yttrium, lutetium, titanium, zirconium or hafnium

each Y is independently halo, hydrogen, a phosphonated, sulfonated or borate anion, or a (1-6C)alkyl, (2-6C)alkenyl, (2-6C)alkynyl, (1-6C)alkoxy, aryl or aryloxy group which is optionally substituted with one or more groups selected from (1-6C)alkyl, halo, nitro, amino, phenyl, (1-6C)alkoxy, —C(O)NRₓR_{y} or —Si[(1-4C)alkyl]₃;
wherein Rₓ and R_{y} are independently (1-4C)alkyl.

The compositions of the invention offer a number of advantages when compared with CGCs currently favoured by industry. In particular, the compositions of the invention have been shown to be as much as six times more catalytically active in the homopolymerisation of ethylene than analogous compositions employing the ansa-bridged cyclopentadienyl amido CGC currently preferred in industry. Furthermore, the compositions of the invention are noticeably more productive than industrial standard catalysts when ethylene is polymerised in the presence of hydrogen, or another alkene (e.g. 1-hexene of styrene).

In an embodiment, R₁ is (1-5C)alkyl, —Si(R₂)₃ or phenyl, either of which is optionally substituted with one or more groups selected from (1-3C)alkyl, wherein each R₂ is independently selected from (1-4C)alkyl.

In an embodiment, R₁ is (1-5C)alkyl, —Si(R₂)₃ or phenyl, either of which is optionally substituted with one or more groups selected from (1-3C)alkyl, wherein each R₂ is independently selected from (1-3C)alkyl.

In another embodiment, R₁ is (2-5C)alkyl, —Si(R₂)₃ or phenyl, either of which is optionally substituted with one or more (e.g. 2 or 3) groups selected from (1-4C)alkyl, wherein each R₂ is independently selected from (1-2C)alkyl.

In another embodiment, R₁ is (2-5C)alkyl, —Si(R₂)₃ or phenyl, either of which is optionally substituted with one or more (e.g. 2 or 3) groups selected from (1-3C)alkyl, wherein each R₂ is independently selected from (1-2C)alkyl.

In another embodiment, R₁ is (2-5C)alkyl or phenyl, either of which is optionally substituted with one or more (e.g. 2 or 3) groups selected from (1-4C)alkyl.

In another embodiment, R₁ is (2-5C)alkyl or phenyl, either of which is optionally substituted with one or more (e.g. 2 or 3) groups selected from (2-4C)alkyl.

In another embodiment, R₁ is methyl, ethyl, iso-propyl, iso-butyl, n-butyl, sec-butyl, tert-butyl, neopentyl, trimethylsilyl, phenyl, mesityl, xylyl, di-isopropylphenyl, tert-butylphenyl or n-butylphenyl.

In another embodiment, R₁ is methyl, ethyl, iso-propyl, iso-butyl, sec-butyl, tert-butyl, neopentyl, trimethylsilyl, phenyl, mesityl, xylyl or di-isopropylphenyl.

In another embodiment, R₁ is (1-5C)alkyl.

In a particularly suitable embodiment, R₁ is n-butyl, tert-butyl, iso-propyl, or phenyl substituted with a (1-4C)alkyl group.

In a particularly suitable embodiment, R₁ is n-butyl, tert-butyl, iso-propyl, or phenyl substituted at the 4-position with a (1-4C)alkyl group.

In a particularly suitable embodiment, R₁ is n-butyl, tert-butyl, iso-propyl, or phenyl substituted at the 4-position with n-butyl or tert-butyl.

In a particularly suitable embodiment, R₁ is tert-butyl or iso-propyl.

In a particularly suitable embodiment, R₁ is tert-butyl.

In another embodiment, Rₐ and R_{b} are independently selected from hydrogen, (1-4C)alkyl, phenyl and benzyl.

In another embodiment, Rₐ and R_{b} are independently selected from hydrogen, (1-3C)alkyl, phenyl and benzyl.

In another embodiment, Rₐ and R_{b} are independently selected from hydrogen or (1-3C)alkyl.

In another embodiment, Rₐ and R_{b} are both methyl or ethyl, or one of Rₐ and R_{b} is methyl and the other is propyl.

In another embodiment, X is titanium, zirconium or hafnium. Suitably, X is zirconium or titanium. More suitably, X is titanium.

In another embodiment, each Y is independently halo, hydrogen, or a (1-4C)alkyl group which is optionally substituted with one or more groups selected from (1-4C)alkyl, halo, nitro, amino, phenyl and (1-4C)alkoxy.

In another embodiment, each Y is independently halo, hydrogen, or a (1-4C)alkyl group which is optionally substituted with one or more groups selected from (1-4C)alkyl, halo and phenyl.

In another embodiment, each Y is independently halo, hydrogen, or (1-4C)alkyl.

In another embodiment, each Y is independently halo. Suitably, at least one Y group is chloro. More suitably, both Y groups are chloro.

In an embodiment, the compound of formula (I) has a structure according to formula (Ia) below:

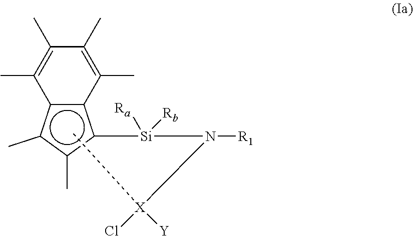

wherein

R₁, Rₐ, R_{b}, X and Y are each independently as defined in any of the paragraphs provided hereinbefore.

In another embodiment, the compound of formula (I) has a structure according to formula (Ia), wherein R₁ is (2-5C)alkyl, —Si(R₂)₃ or phenyl, either of which is optionally substituted with one or more (e.g. 2 or 3) groups selected from (1-4C)alkyl, wherein each R₂ is independently selected from (1-2C)alkyl.

In another embodiment, the compound of formula (I) has a structure according to formula (Ia), wherein R₁ is methyl, ethyl, iso-propyl, iso-butyl, n-butyl, sec-butyl, tert-butyl, neopentyl, trimethylsilyl, phenyl, mesityl, xylyl, di-isopropylphenyl, tert-butylphenyl or n-butylphenyl.

In another embodiment, the compound of formula (I) has a structure according to formula (Ia), wherein R₁ is methyl, ethyl, iso-propyl, iso-butyl, sec-butyl, tert-butyl, neopentyl, trimethylsilyl, phenyl, mesityl, xylyl or di-isopropylphenyl. Suitably, R₁ is methyl, ethyl, iso-propyl, iso-butyl, sec-butyl, tert-butyl or neopentyl. Even more suitably, R₁ is tert-butyl.

In another embodiment, the compound of formula (I) has a structure according to formula (Ia), wherein R₁ is n-butyl, tert-butyl, iso-propyl, or phenyl substituted with a (1-4C)alkyl group.

In another embodiment, the compound of formula (I) has a structure according to formula (Ia), wherein Rₐ and R_{b} are independently selected from hydrogen or (1-3C)alkyl. Suitably, Rₐ and R_{b} are both methyl or ethyl, or one of Rₐ and R_{b} is methyl and the other is propyl.

In another embodiment, the compound of formula (I) has a structure according to formula (Ia), wherein X is titanium or zirconium.

In another embodiment, the compound of formula (I) has a structure according to formula (Ia), wherein X is titanium.

In another embodiment, the compound of formula (I) has a structure according to formula (Ia), wherein each Y is independently halo, hydrogen, or (1-4C)alkyl.

In an embodiment, the compound of formula (I) has a structure according to formula (Ib) below:

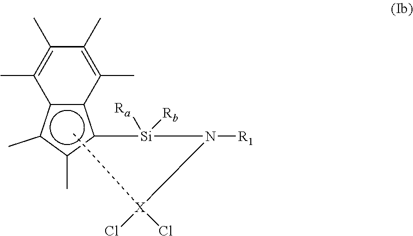

wherein

R₁, Rₐ, R_{b} and X are as defined in any of the paragraphs provided hereinbefore.

In another embodiment, the compound of formula (I) has a structure according to formula (Ib), wherein R₁ is (2-5C)alkyl, —Si(R₂)₃ or phenyl, either of which is optionally substituted with one or more (e.g. 2 or 3) groups selected from (1-4C)alkyl, wherein each R₂ is independently selected from (1-2C)alkyl.

In another embodiment, the compound of formula (I) has a structure according to formula (Ib), wherein R₁ is methyl, ethyl, iso-propyl, iso-butyl, n-butyl, sec-butyl, tert-butyl, neopentyl, trimethylsilyl, phenyl, mesityl, xylyl, di-isopropylphenyl, tert-butylphenyl or n-butylphenyl.

In another embodiment, the compound of formula (I) has a structure according to formula (Ib), wherein R₁ is methyl, ethyl, iso-propyl, iso-butyl, sec-butyl, tert-butyl, neopentyl, trimethylsilyl, phenyl, mesityl, xylyl or di-isopropylphenyl. Suitably, R₁ is methyl, ethyl, iso-propyl, iso-butyl, sec-butyl, tert-butyl or neopentyl. Even more suitably, R₁ is tert-butyl.

In another embodiment, the compound of formula (I) has a structure according to formula (Ib), wherein R₁ is n-butyl, tert-butyl, iso-propyl, or phenyl substituted with a (1-4C)alkyl group.

In another embodiment, the compound of formula (I) has a structure according to formula (Ib), wherein Rₐ and R_{b} are independently selected from hydrogen or (1-3C)alkyl. Suitably, Rₐ and R_{b} are both methyl or ethyl, or one of Rₐ and R_{b} is methyl and the other is propyl.

In another embodiment, the compound of formula (I) has a structure according to formula (Ib), wherein X is titanium or zirconium.

In another embodiment, the compound of formula (I) has a structure according to formula (Ib), wherein X is titanium.

In an embodiment, the compound of formula (I) has a structure according to formula (Ic) below:

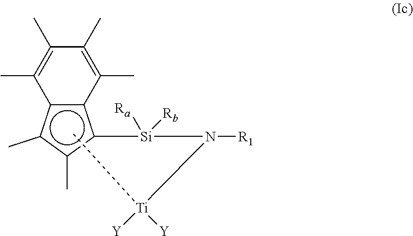

wherein

R₁, Rₐ, R_{b} and Y are each independently as defined in any of the paragraphs provided hereinbefore.

In another embodiment, the compound of formula (I) has a structure according to formula (Ic), wherein R₁ is (2-5C)alkyl, —Si(R₂)₃ or phenyl, either of which is optionally substituted with one or more (e.g. 2 or 3) groups selected from (1-4C)alkyl, wherein each R₂ is independently selected from (1-2C)alkyl.

In another embodiment, the compound of formula (I) has a structure according to formula (Ic), wherein R₁ is methyl, ethyl, iso-propyl, iso-butyl, n-butyl, sec-butyl, tert-butyl, neopentyl, trimethylsilyl, phenyl, mesityl, xylyl, di-isopropylphenyl, tert-butylphenyl or n-butylphenyl.

In another embodiment, the compound of formula (I) has a structure according to formula (Ic), wherein R₁ is methyl, ethyl, iso-propyl, iso-butyl, sec-butyl, tert-butyl, neopentyl, trimethylsilyl, phenyl, mesityl, xylyl or di-isopropylphenyl. Suitably, R₁ is methyl, ethyl, iso-propyl, iso-butyl, sec-butyl, tert-butyl or neopentyl. Even more suitably, R₁ is tert-butyl.

In another embodiment, the compound of formula (I) has a structure according to formula (Ic), wherein R₁ is n-butyl, tert-butyl, iso-propyl, or phenyl substituted with a (1-4C)alkyl group.

In another embodiment, the compound of formula (I) has a structure according to formula (Ic), wherein Rₐ and R_{b} are independently selected from hydrogen or (1-3C)alkyl. Suitably, Rₐ and R_{b} are both methyl or ethyl, or one of Rₐ and R_{b} is methyl and the other is propyl.

In another embodiment, the compound of formula (I) has a structure according to formula (Ic), wherein each Y is independently halo, hydrogen, or (1-4C)alkyl.

In another embodiment, the compound of formula (I) has a structure according to formula (Ic), wherein each Y is independently halo. Suitably, at least one Y group is chloro. More suitably, both Y groups are chloro.

In another embodiment, the compound of formula (I) has a structure according to formula (Ic), wherein at least one Y group is chloro and the other is (1-4C)alkyl.

In an embodiment, the compound of formula (I) has a structure according to formula (Id) below:

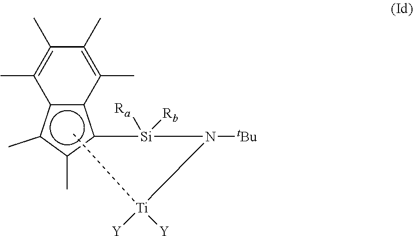

wherein

Rₐ, R_{b} and Y are each independently as defined in any of the paragraphs provided hereinbefore.

In another embodiment, the compound of formula (I) has a structure according to formula (Id), wherein Rₐ and R_{b} are independently selected from hydrogen or (1-3C)alkyl. Suitably, Rₐ and R_{b} are both methyl or ethyl, or one of Rₐ and R_{b} is methyl and the other is propyl.

In another embodiment, the compound of formula (I) has a structure according to formula (Id), each Y is independently halo, hydrogen, or (1-4C)alkyl.

In another embodiment, the compound of formula (I) has a structure according to formula (Id), wherein each Y is independently halo. Suitably, at least one Y group is chloro. More suitably, both Y groups are chloro.

In another embodiment, the compound of formula (I) has a structure according to formula (Id), wherein at least one Y group is chloro and the other is (1-4C)alkyl.

In an embodiment, the compound of formula (I) has a structure according to formula (Ie) below:

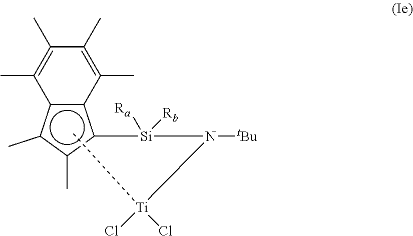

wherein

Rₐ and R_{b} are each independently as defined in any of the paragraphs provided hereinbefore.

In another embodiment, the compound of formula (I) has a structure according to formula (Ie), wherein Rₐ and R_{b} are independently selected from hydrogen or (1-3C)alkyl. Suitably, Rₐ and R_{b} are both methyl or ethyl, or one of Rₐ and R_{b} is methyl and the other is propyl.

In a particularly suitable embodiment, the compound of formula (I) has any of the following structures:

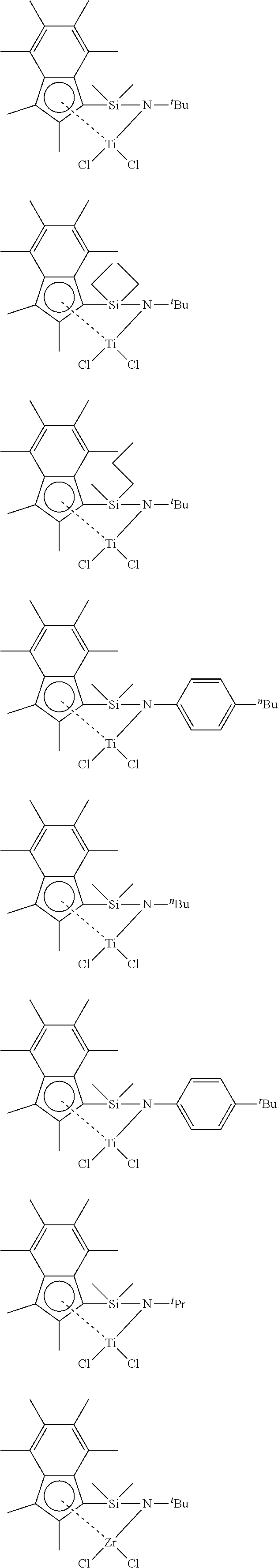

In a particularly suitable embodiment, the compound of formula (I) has any of the following structures:

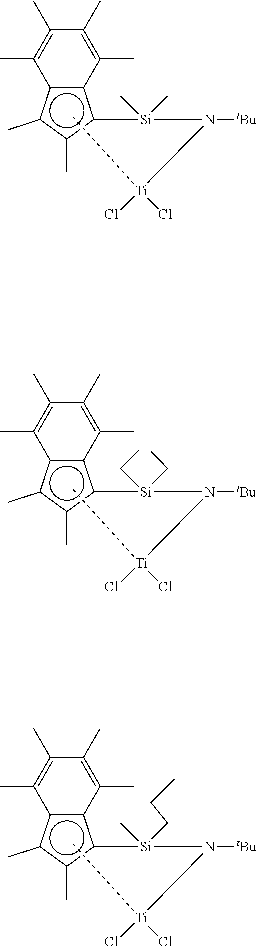

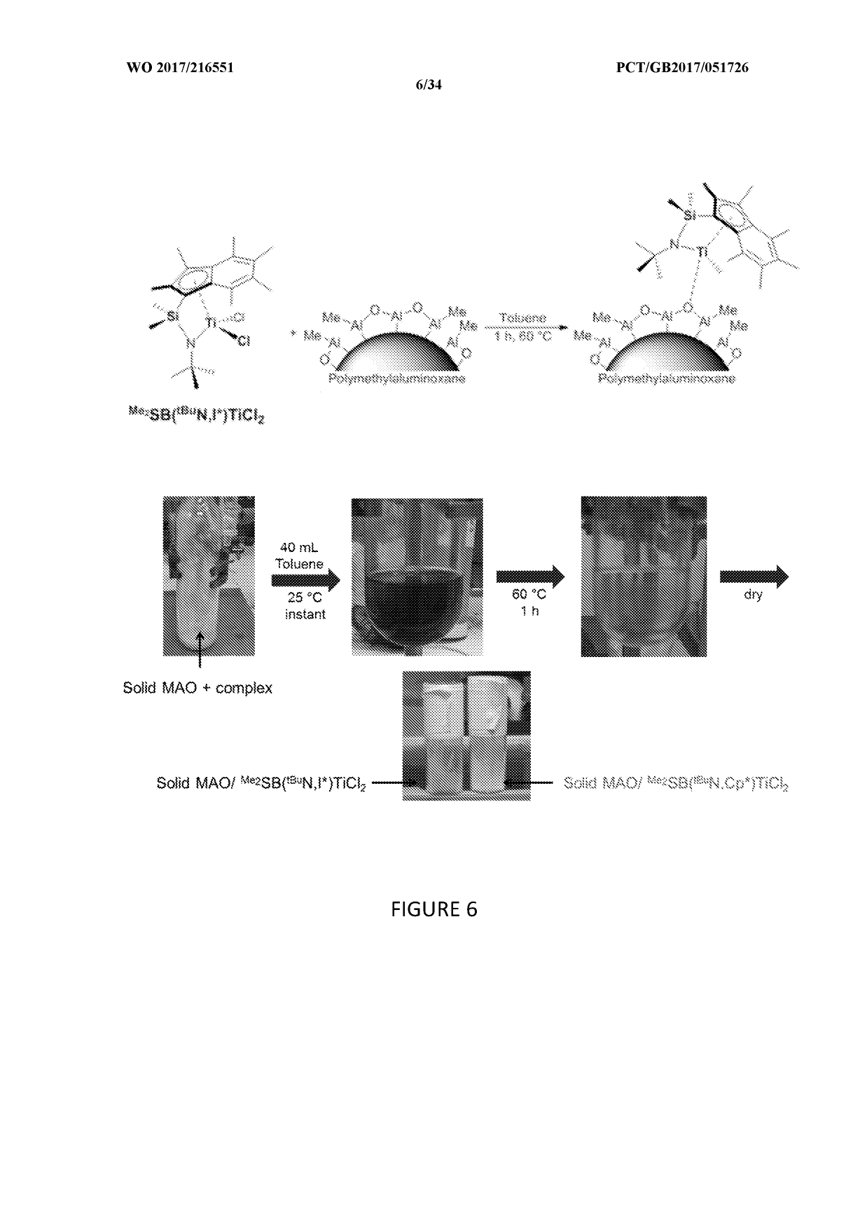

The compound of formula (I) may be associated with the solid polymethylaluminoxane support material by one or more ionic or covalent interactions. It will be understood that any minor structural modifications to the compound of formula (I) arising from it being associated with the solid polymethylaluminoxane support material are within the scope of this invention. For example, without wishing to be bound by theory, the compound of formula (I) may be associated with solid polymethylaluminoxane as illustrated in FIG. 6 (i.e. by replacement of one of the Y groups with a bond to oxygen on the surface of the solid polymethylaluminoxane).

The terms “solid MAO” and “solid polymethylaluminoxane” are used synonymously herein to refer to a solid-phase material having the general formula -[(Me)AlO]ₙ—, wherein n is an integer from 4 to 50 (e.g. 10 to 50). Any suitable solid polymethylaluminoxane may be used.

There exist numerous substantial structural and behavioural differences between solid polymethylaluminoxane and other (non-solid) MAOs. Perhaps most notably, solid polymethylaluminoxane is distinguished from other MAOs as it is insoluble in hydrocarbon solvents and so acts as a heterogeneous support system. The solid polymethylaluminoxane useful in the compositions of the invention are insoluble in toluene and hexane.

In contrast to non-solid (hydrocarbon-soluble) MAOs, which are traditionally used as an activator species in slurry polymerisation or to modify the surface of a separate solid support material (e.g. SiO₂), the solid polymethylaluminoxanes useful as part of the present invention are themselves suitable for use as solid-phase support materials, without the need for an additional activator. Hence, compositions of the invention comprising solid polymethylaluminoxane are devoid of any other species that could be considered a solid support (e.g. inorganic material such as SiO₂, Al₂O₃ and ZrO₂). Moreover, given the dual function of the solid polymethylaluminoxane (as catalytic support and activator species), the compositions of the invention comprising solid MAO may contain no additional catalytic activator species.

In an embodiment, the solid polymethylaluminoxane is prepared by heating a solution containing MAO and a hydrocarbon solvent (e.g. toluene), so as to precipitate solid polymethylaluminoxane. The solution containing MAO and a hydrocarbon solvent may be prepared by reacting trimethyl aluminium and benzoic acid in a hydrocarbon solvent (e.g. toluene), and then heating the resulting mixture.

In an embodiment, the solid polymethylaluminoxane is prepared according to the following protocol:

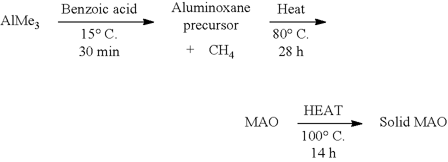

The properties of the solid polymethylaluminoxane can be adjusted by altering one or more of the processing variables used during its synthesis. For example, in the above-outlined protocol, the properties of the solid polymethylaluminoxane may be adjusted by varying the Al:O ratio, by fixing the amount of AlMe₃ and varying the amount of benzoic acid. Exemplary Al:O ratios are 1:1, 1.1:1, 1.2:1, 1.3:1, 1.4:1 and 1.6:1. Suitably the Al:O ratio is 1.2:1 or 1.3:1. Alternatively, the properties of the solid polymethylaluminoxane may be adjusted by fixing the amount of benzoic acid and varying the amount of AlMe₃.

In another embodiment, the solid polymethylaluminoxane is prepared according to the following protocol:

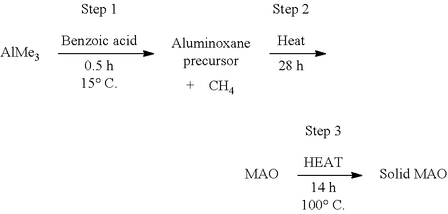

In the above protocol, steps 1 and 2 may be kept constant, with step 2 being varied. The temperature of step 2 may be 70-100° C. (e.g. 70° C., 80° C., 90° C. or 100° C.). The duration of step 2 may be from 12 to 28 hours (e.g. 12, 20 or 28 hours). The duration of step 2 may be from 5 minutes to 24 hours. Step 3 may be conducted in a solvent such as toluene.

In an embodiment, the aluminium content of the solid polymethylaluminoxane falls within the range of 36-41 wt %.

The solid polymethylaluminoxane useful as part of the present invention is characterised by extremely low solubility in toluene and n-hexane. In an embodiment, the solubility in n-hexane at 25° C. of the solid polymethylaluminoxane is 0-2 mol %. Suitably, the solubility in n-hexane at 25° C. of the solid polymethylaluminoxane is 0-1 mol %. More suitably, the solubility in n-hexane at 25° C. of the solid polymethylaluminoxane is 0-0.2 mol %. Alternatively or additionally, the solubility in toluene at 25° C. of the solid polymethylaluminoxane is 0-2 mol %. Suitably, the solubility in toluene at 25° C. of the solid polymethylaluminoxane is 0-1 mol %. More suitably, the solubility in toluene at 25° C. of the solid polymethylaluminoxane is 0-0.5 mol %. The solubility in solvents can be measured by the method described in JP-B(KOKOKU)-H07 42301.

In a particularly suitable embodiment, the solid polymethylaluminoxane is as described in US2013/0059990, WO2010/055652 or WO2013/146337, and is obtainable from Tosoh Finechem Corporation, Japan.

In an embodiment, the mole ratio of solid polymethylaluminoxane to the compound of formula (I) is 50:1 to 500:1. Suitably, the mole ratio of solid polymethylaluminoxane to the compound of formula (I) is 75:1 to 400:1. More suitably, the mole ratio of solid polymethylaluminoxane to the compound of formula (I) is 100:1 to 300:1.

### Preparation of Compositions of Invention

The compounds of formula (I) may be synthesised by any suitable process known in the art. Particular examples of processes for the preparing compounds of formula (I) are set out in the accompanying examples.

Suitably, a compound of formula (I) is prepared by:

(i) reacting a compound of formula A:

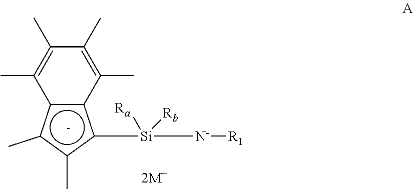

(wherein R₁, Rₐ and R_{b} are each as defined hereinbefore and M is Li, Na or K) with a compound of the formula B:

X(Y′)₄ B
(wherein X is as defined hereinbefore and Y′ is halo (particularly chloro or bromo)) in the presence of a suitable solvent to form a compound of formula (I′):

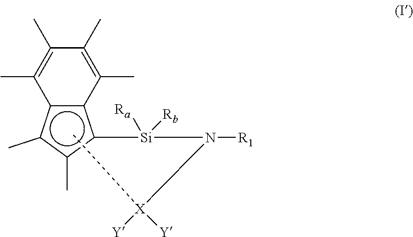

and optionally thereafter:
(ii) reacting the compound of formula Ia above with MY″ (wherein M is as defined above and Y″ is a group Y as defined herein other than halo), in the presence of a suitable solvent to form the compound of the formula (I″) shown below

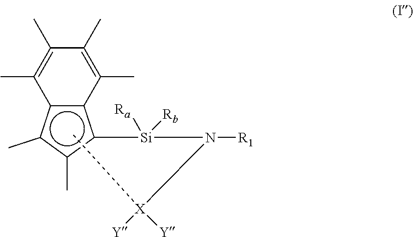

Suitably, M is Li in step (i) of the process defined above.

Suitably, the compound of formula B is provided as a solvate. In particular, the compound of formula B may be provided as X(Y)₄.THFₚ, where p is an integer (e.g. 2).

Any suitable solvent may be used for step (i) of the process defined above. A particularly suitable solvent is toluene or THF.

If a compound of formula (I) in which Y is other than halo is required, then the compound of formula (I′) above may be further reacted in the manner defined in step (ii) to provide a compound of formula (I″).

Any suitable solvent may be used for step (ii) of the process defined above. A suitable solvent may be, for example, diethyl ether, toluene, THF, dichloromethane, chloroform, hexane DMF, benzene etc.

Compounds of formula A may generally be prepared by:
(i) Reacting a compound of formula C:

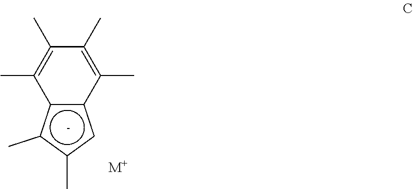

(wherein M is lithium, sodium, or potassium) with one equivalent of a compound having formula D shown below:

Si(Rₐ)(R_{b})(Cl)₂ D
(wherein Rₐ and R_{b} are as defined hereinbefore)
to form the compound of the formula E shown below:

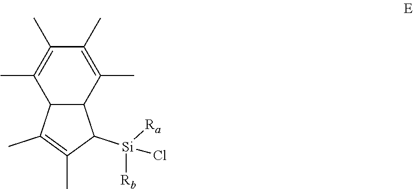

(ii) Reacting the compound of formula E with a compound of formula F shown below:

R₁—N(H)Li F
(wherein R₁ is as defined hereinbefore, and wherein Li may be substituted for K or Na).

Compounds of formulae A and F can be readily synthesized by techniques well known in the art.

Any suitable solvent may be used for step (i) of the above process. A particularly suitable solvent is THF.

Similarly, any suitable solvent may be used for step (ii) of the above process. A suitable solvent may be, for example, toluene, THF, DMF etc.

A person of skill in the art will be able to select suitable reaction conditions (e.g. temperature, pressures, reaction times, agitation etc.) for such a synthesis.

Once prepared, the compound of formula (I) may be associated with the solid polymethylaluminoxane by any suitable means. For example, the compound of formula (I) may be associated with the solid polymethylaluminoxane by contacting the compound of formula (I) with the solid polymethylaluminoxane in a suitable solvent (e.g. toluene) with heating, and then isolating the resulting coloured solid.

### Uses of the Compositions

As described hereinbefore, the present invention also provides a use of a composition as defined herein in the polymerisation of ethylene and optionally one or more (3-10C)alkene.

The compositions of the invention may be used as catalysts in the preparation of a variety of polymers, including polyalkylenes (e.g. polyethylene) of varying molecular weight, and copolymers. Such polymers and copolymers may be prepared by heterogeneous slurry-phase polymerisation of a monomer-containing feed stream.

In an embodiment, when the optional one or more (3-10C)alkene is not included, the compositions of the invention may be used to prepare polyethylene homopolymers.

In another embodiment, the optional one or more (3-10C)alkene (which may be an α-olefin) is one or more (3-8C)alkene. Suitably, the quantity of the one or more (3-8C)alkene in the monomer feed stream is 0.05-10 mol %, relative to the quantity of ethylene monomers. More suitably, the one or more (3-8C)alkene is selected from 1-hexene, 1-octene and styrene. Hence, the composition of the present invention are useful as catalysts in the preparation of copolymers such as poly(ethylene-co-hexene), poly(ethylene-co-octene) and poly(ethylene-co-styrene).

In a particularly suitable embodiment, the compositions of the invention are used to copolymerise ethylene and styrene.

In a particularly suitable embodiment, the compositions of the invention are used to copolymerise ethylene and 1-hexene.

In another embodiment, in addition to ethylene and the optional one or more (3-10C)alkene, the polymerisation is also conducted in the presence of hydrogen. Hydrogen acts to control the molecular weight of the growing polymer or copolymer. When hydrogen is used alongside ethylene and the optional one or more (3-10C)alkene in the feed stream, the mole ratio of hydrogen to total alkenes in the feed stream is 0.001:1 to 0.5:1. Suitably, when hydrogen is used alongside ethylene and the optional one or more (3-10C)alkene, the mole ratio of hydrogen to total alkenes in the feed stream is 0.001:1 to 0.1:1. More suitably, when hydrogen is used alongside ethylene and the optional one or more (3-10C)alkene, the mole ratio of hydrogen to total alkenes in the feed stream is 0.001:1 to 0.05:1. When compared with analogous compositions employing the ansa-bridged cyclopentadienyl amido CGC currently preferred in industry, the compositions of the present invention show only a marginal decrease in catalytic productivity with increasing quantity of hydrogen in the feed stream.

As described hereinbefore, the present invention also provides a polymerisation process comprising the step of:
a) polymerising ethylene and optionally one or more (3-10C)alkene in the presence of a composition as defined herein.

The compositions of the invention may be used as catalysts in the preparation of a variety of polymers, including polyalkylenes (e.g. polyethylene) of varying molecular weight, and copolymers. Such polymers and copolymers may be prepared by heterogeneous slurry-phase polymerisation of a monomer-containing feed stream.

In an embodiment, step a) is conducted at a temperature of 30-120° C. Suitably, step a) is conducted at a temperature of 40-80° C.

In another embodiment, step a) is conducted at a pressure of 1-10 bar.

In another embodiment, step a) is conducted in a suitable solvent (e.g. hexanes or heptane).

In another embodiment, step a) is conducted in the presence of a compound suitable for scavenging moisture and oxygen. Exemplary moisture and oxygen scavengers include alkylaluminium compounds, including triethylaluminium (TEA), triisobutylaluminium (TIBA) and methylaluminoxane (MAO). Suitably, the moisture/oxygen scavenger is triisobutylaluminium (TIBA) or methylaluminoxane (MAO).

In another embodiment, step a) may be conducted for between 1 minute and 5 hours. Suitably, step a) may be conducted for between 5 minutes and 2 hours.

In another embodiment, when the optional one or more (3-10C)alkene is not included, the process yields polyethylene homopolymer.

In another embodiment, the optional one or more (3-10C)alkene is one or more (3-8C)alkene. Suitably, the quantity of the one or more (3-8C)alkene in the monomer feed stream is 0.05-10 mol %, relative to the quantity of ethylene monomers. More suitably, the one or more (3-8C)alkene is selected from 1-hexene, 1-octene and styrene. Hence, the process may be used to prepare copolymers such as poly(ethylene-co-hexene), poly(ethylene-co-octene) and poly(ethylene-co-styrene).

In a particularly suitable embodiment, step a) comprises copolymerising ethylene and styrene in the presence of a composition as defined herein.

In a particularly suitable embodiment, step a) comprises copolymerising ethylene and 1-hexene in the presence of a composition as defined herein.

In another embodiment, in addition to ethylene and the optional one or more (3-10C)alkene, the polymerisation is also conducted in the presence of hydrogen. Hydrogen acts to control the molecular weight of the growing polymer or copolymer. When hydrogen is used alongside ethylene and the optional one or more (3-10C)alkene in the feed stream, the mole ratio of hydrogen to total alkenes in the feed stream is 0.001:1 to 0.5:1. Suitably, when hydrogen is used alongside ethylene and the optional one or more (3-10C)alkene, the mole ratio of hydrogen to total alkenes in the feed stream is 0.001:1 to 0.1:1. More suitably, when hydrogen is used alongside ethylene and the optional one or more (3-10C)alkene, the mole ratio of hydrogen to total alkenes in the feed stream is 0.001:1 to 0.05:1. When compared with analogous compositions employing the ansa-bridged cyclopentadienyl amido CGC currently preferred in industry, the compositions of the present invention show only a marginal decrease in catalytic productivity with increasing quantity of hydrogen in the feed stream.

Particular examples of the invention will now be described, for the purpose of illustration only, with reference to the accompanying figures, in which:

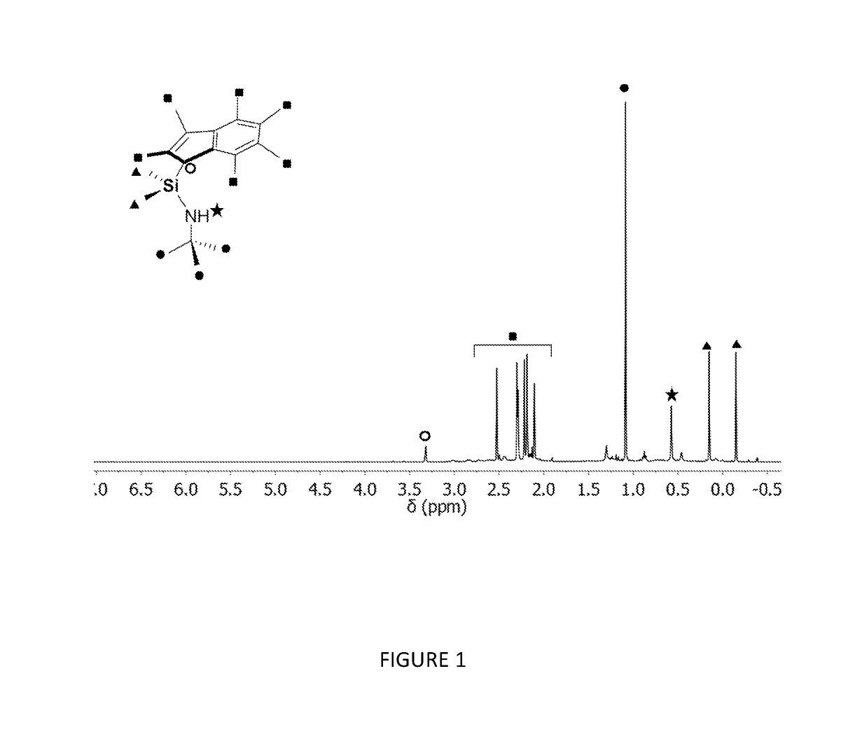

FIG. 1 shows the ¹H NMR spectrum (400 MHz, benzene-d₆, 23° C.) of ^{Me2}SB(^{tBu}N,I*)H₂.

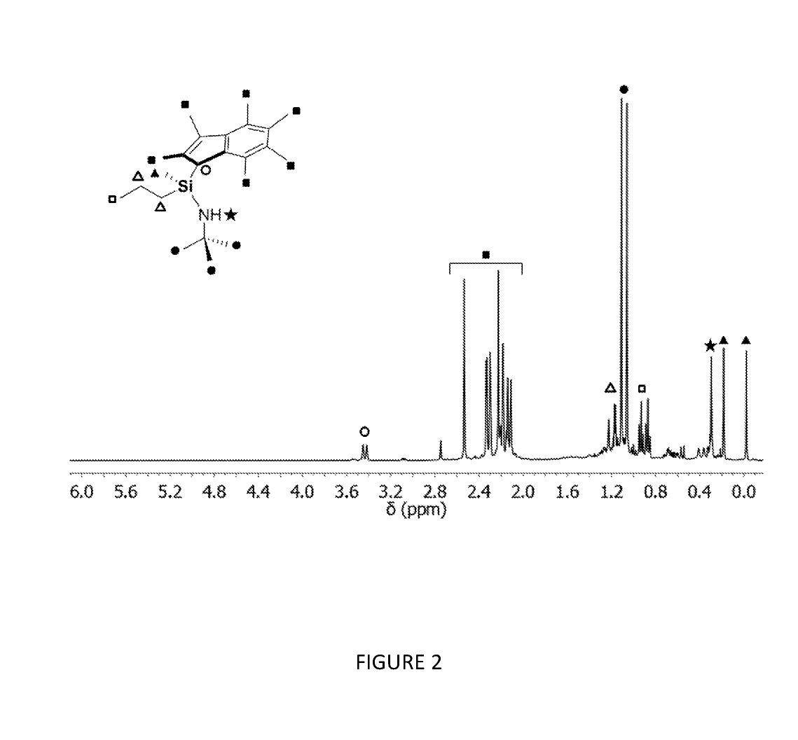

FIG. 2 shows the ¹H NMR spectrum (400 MHz, benzene-d₆, 23° C.) of ^{Me,Propyl}SB(^{tBu}N,I*)H₂.

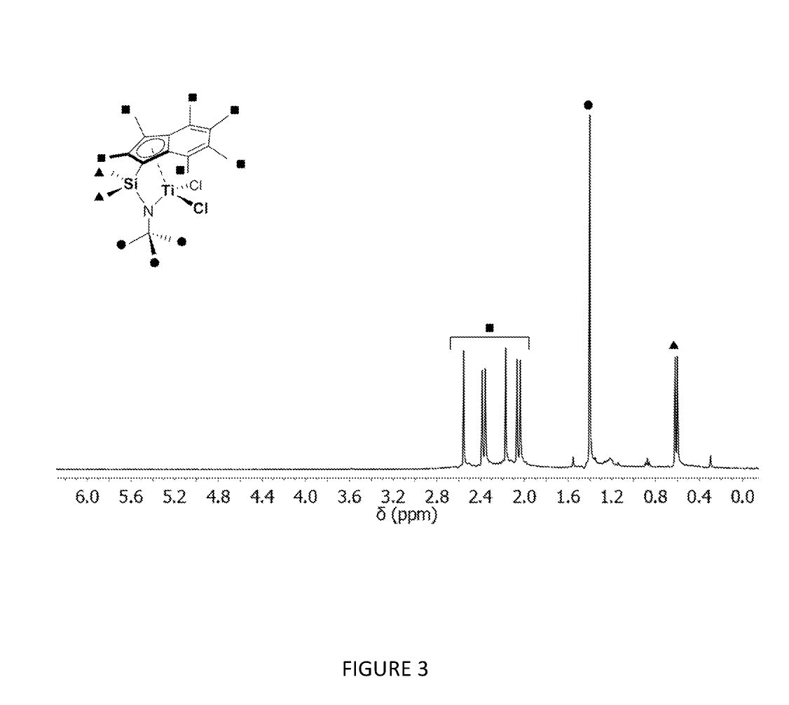

FIG. 3 shows the ¹H NMR spectrum (400 MHz, benzene-d₆, 23° C.) of ^{Me2}SB(^{tBu}N,I*)TiCl₂.

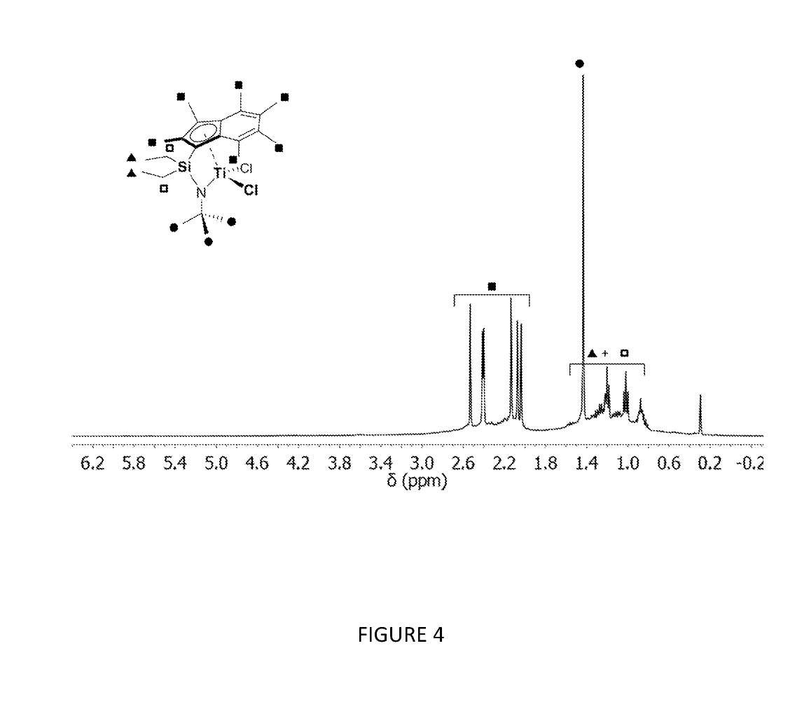

FIG. 4 shows the ¹H NMR spectrum (400 MHz, benzene-d₆, 23° C.) of ^{Et2}SB(^{tBu}N,I*)TiCl₂.

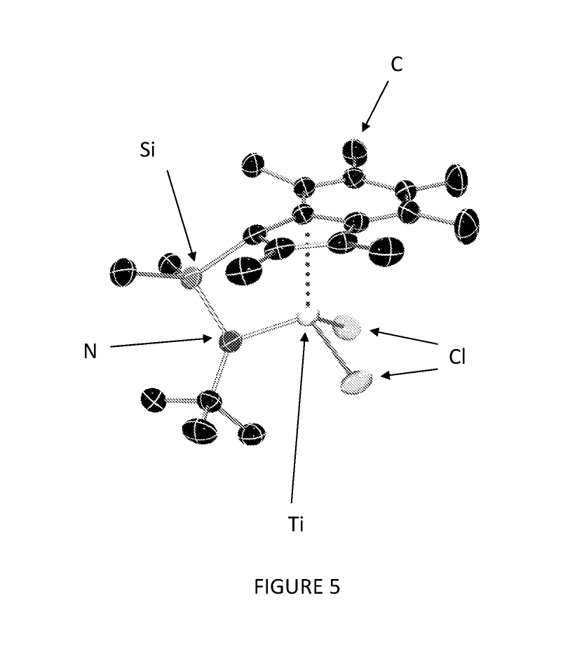

FIG. 5 shows the molecular structure of ^{Me2}SB(^{tBu}N,I*)TiCl₂.

FIG. 6 shows the synthetic pathway for the preparation of the solid MAO/^{Me2}SB(^{tBu}N,I*)TiCl₂ composition of the invention, as well as a visual comparison with the solid MAO/^{Me2}SB(^{tBu}N,Cp*)TiCl₂ comparator composition.

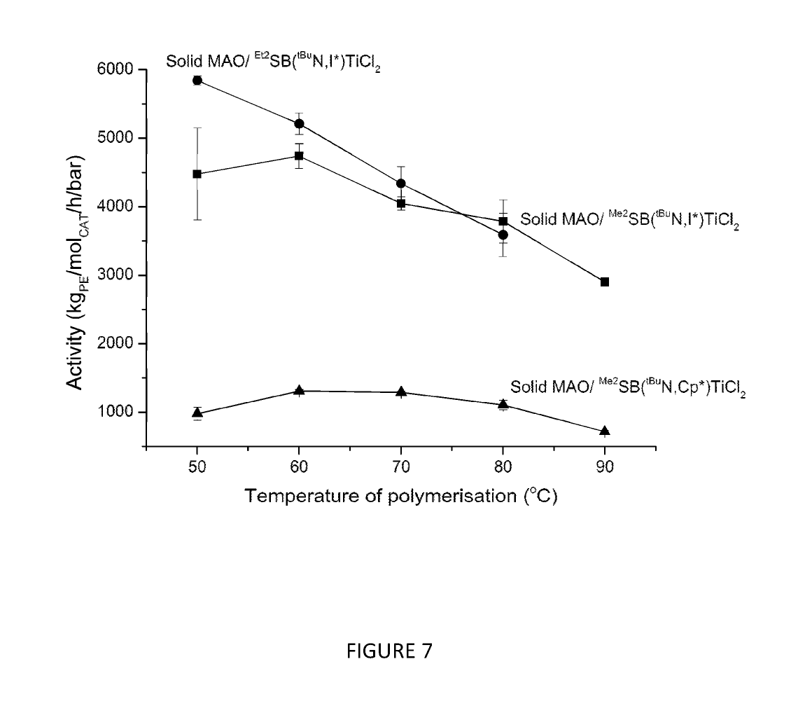

FIG. 7 shows the slurry polymerisation of ethylene using solid MAO/^{Me2}SB(^{tBu}N,I*)TiCl₂ (black square), solid MAO/^{Me2}SB(^{tBu}N,I*)TiCl₂ (black circle) and solid MAO/^{Me2}SB(^{tBu}N,Cp*)TiCl₂ (black triangle). Polymerisation conditions: 2 bar of ethylene, 10 mg of catalyst, 30 minutes, [Al]₀[Ti]₀=200, 150 mg of TIBA and 50 mL hexanes.

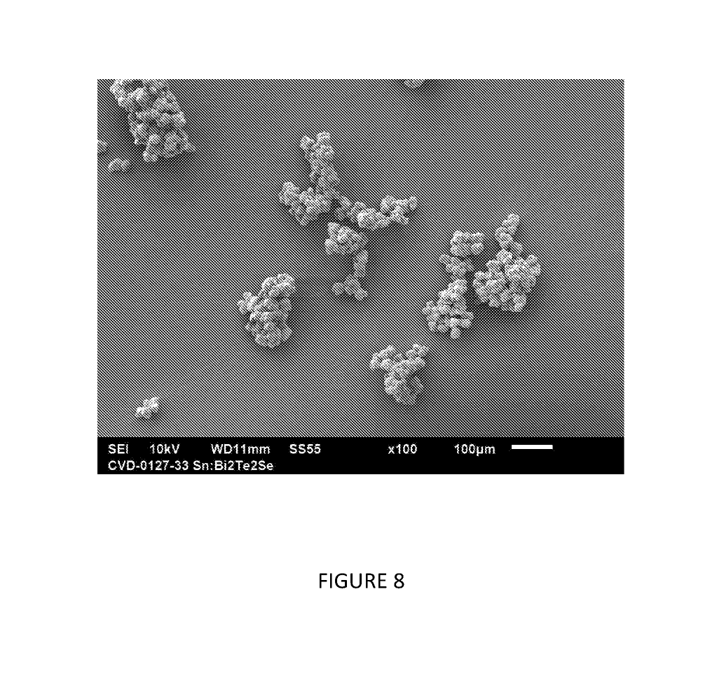

FIG. 8 shows an SEM image of the PE synthesised using solid MAO/^{Me2}SB(^{tBu}N,I*)TiCl₂. Polymerisation conditions: 2 bar of ethylene, 10 mg of catalyst, 70° C., 30 minutes, [Al]₀/[Ti]₀=200, 150 mg of TIBA and 50 mL hexanes.

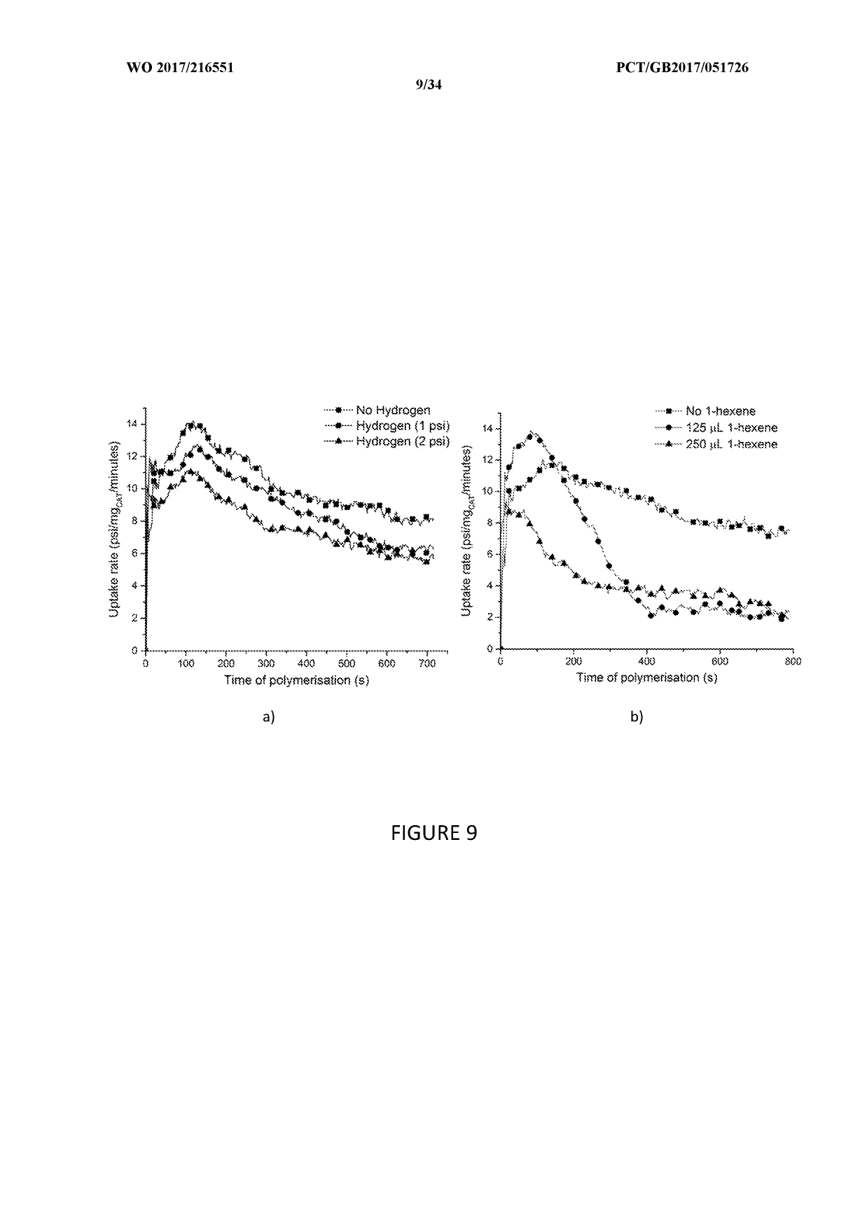

FIG. 9 shows the ethylene uptake rate for the slurry polymerisation of ethylene using solid MAO/^{Me2}SB(^{tBu}N,I*)TiCl₂ for hydrogen response (a)) and copolymerisation of ethylene and 1-hexene (b)). Polymerisation conditions: 8 bar of ethylene, 0.05 mg of catalyst, 80° C., 10 μmol of TIBA and 5 mL heptane.

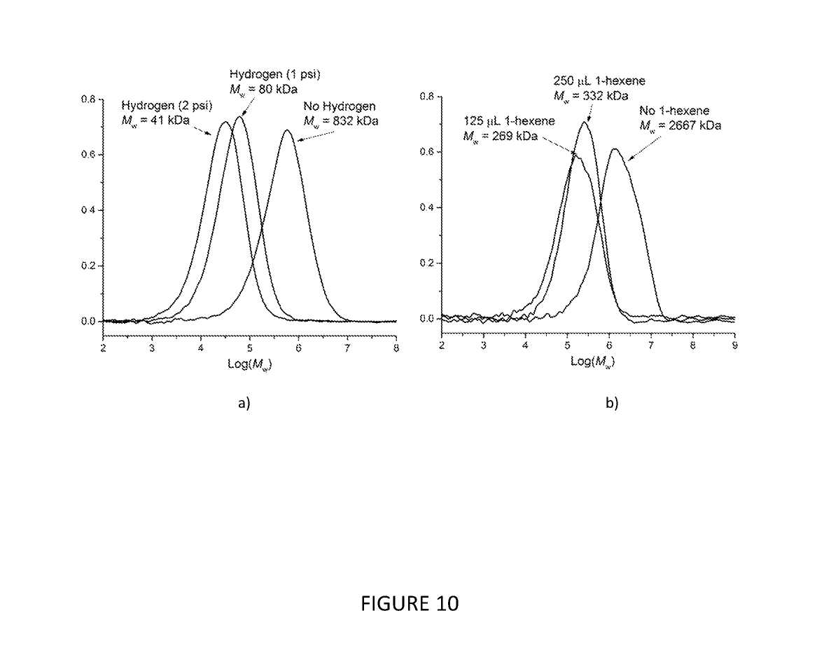

FIG. 10 shows GPC traces for the slurry polymerisation of ethylene using solid MAO/^{Me2}SB(^{tBu}N,I*)TiCl₂ for hydrogen response (a)) and copolymerisation of ethylene and 1-hexene (b)). Polymerisation conditions: 8 bar of ethylene, 0.05 mg of catalyst, 80° C., 10 μmol of TIBA and 5 mL heptane.

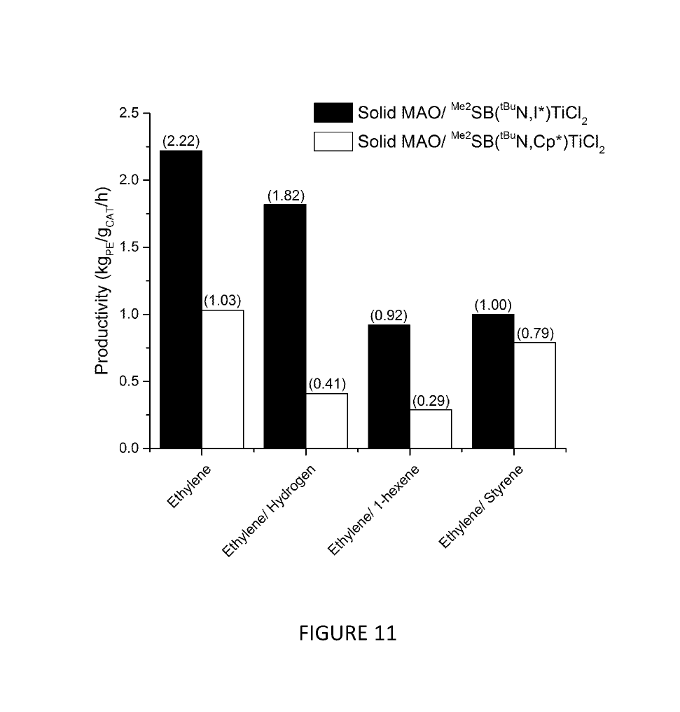

FIG. 11 shows the productivity of polymerisation for various polymerisation conditions (homopolymerisation of ethylene; addition of hydrogen in homopolymerisation of ethylene; copolymerisation of ethylene and 1-hexene; and copolymerisation of ethylene with styrene) using Solid MAO/^{Me2}SB(^{tBu}N,I*)TiCl₂ (black column) and Solid MAO/^{Me2}SB(^{tBu}N,Cp*)TiCl₂ (white column). Productivities are in parentheses. Polymerisation conditions: 8 bar of ethylene, 25-50 mg of catalyst, [Al]₀/[Ti]₀=100, 70° C., TEA and 1000 mL hexane.

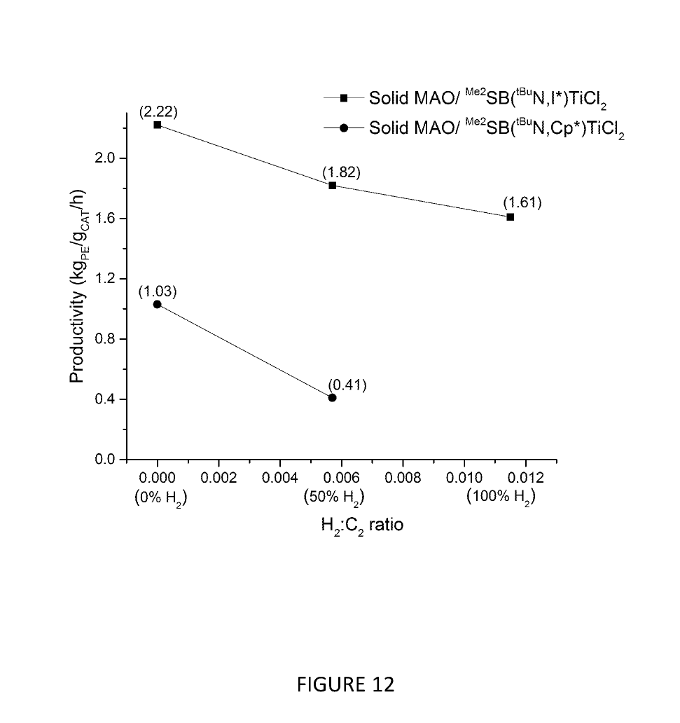

FIG. 12 shows the productivity of ethylene homopolymerisation with and without hydrogen using Solid MAO/^{Me2}SB(^{tBu}N,I*)TiCl₂ (black square) and Solid MAO/^{Me2}SB(^{tBu}N,Cp*)TiCl₂ (black circle). Polymerisation conditions: Polymerisation conditions: 8 bar of ethylene, 25-50 mg of catalyst, [Al]₀/[Ti]₀=100, 70° C., TEA and 1000 mL hexane.

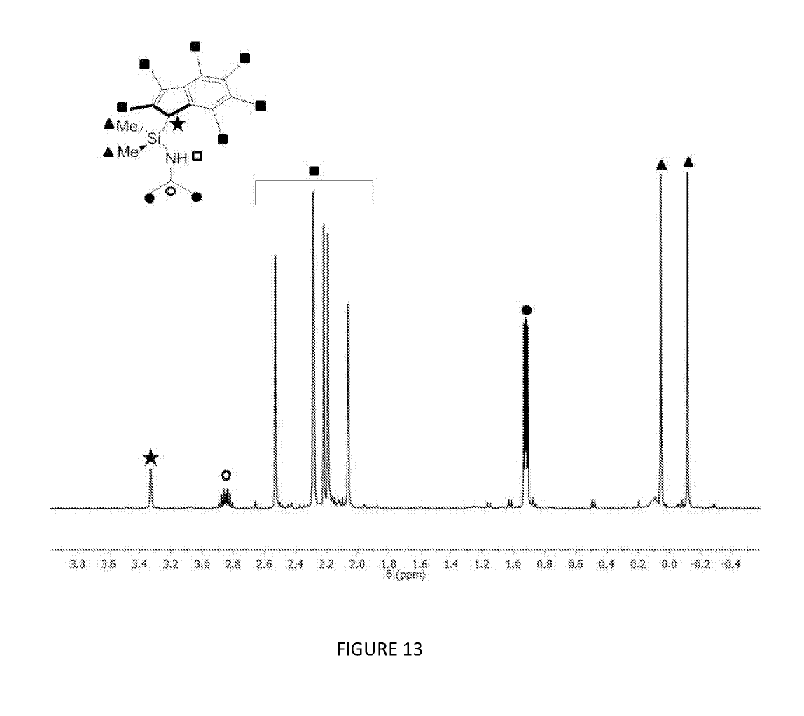

FIG. 13 shows the ¹H NMR spectrum (400 MHz, benzene-d₆, 23° C.) of ^{Me2}SB(^{iPr}N,I*)H₂.

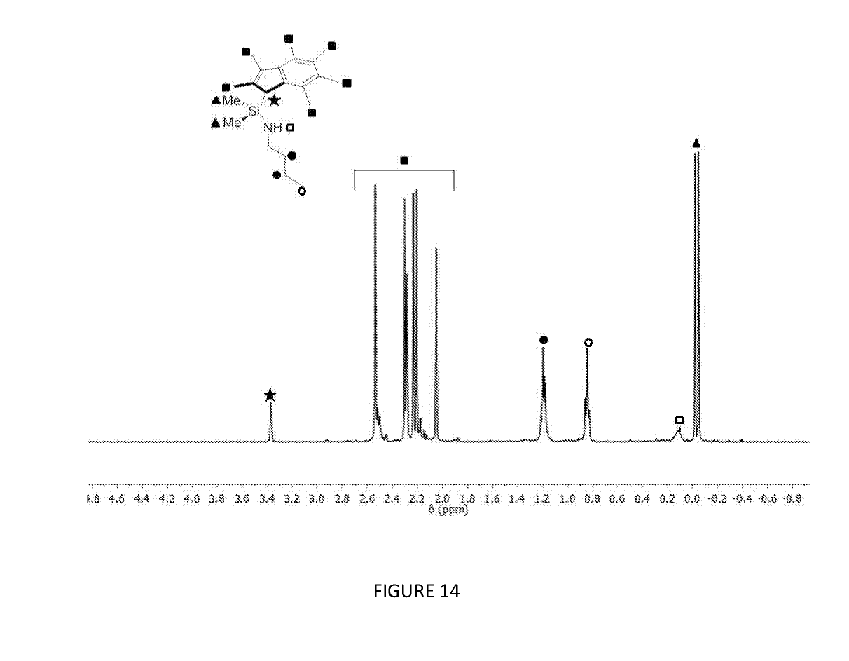

FIG. 14 shows the ¹H NMR spectrum (400 MHz, benzene-d₆, 23° C.) of ^{Me2}SB(^{nBu}N,I*)H₂.

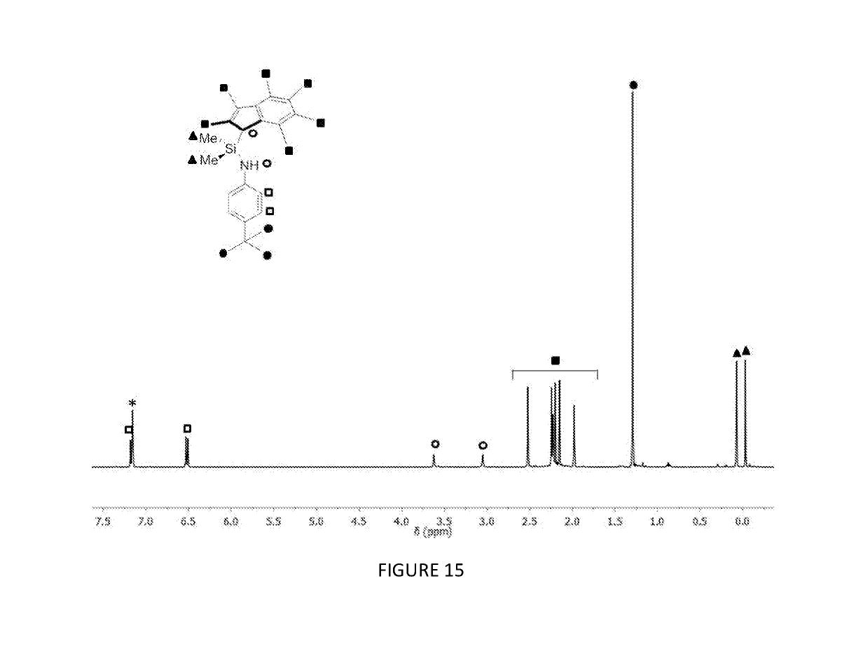

FIG. 15 shows the ¹H NMR spectrum (400 MHz, benzene-d₆, 23° C.) of ^{Me2}SB(^{4tBuPh}N,I*)H₂.

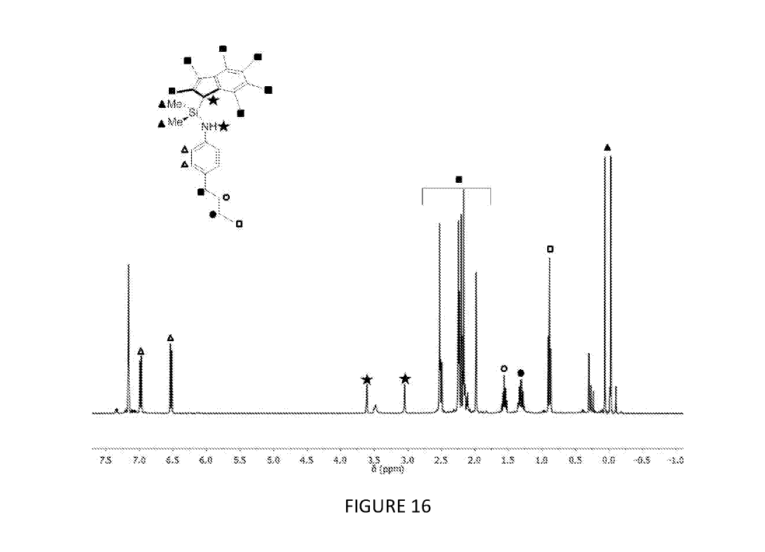

FIG. 16 shows the ¹H NMR spectrum (400 MHz, benzene-d₆, 23° C.) of ^{Me2}SB(^{4nBuPh}N,I*)H₂.

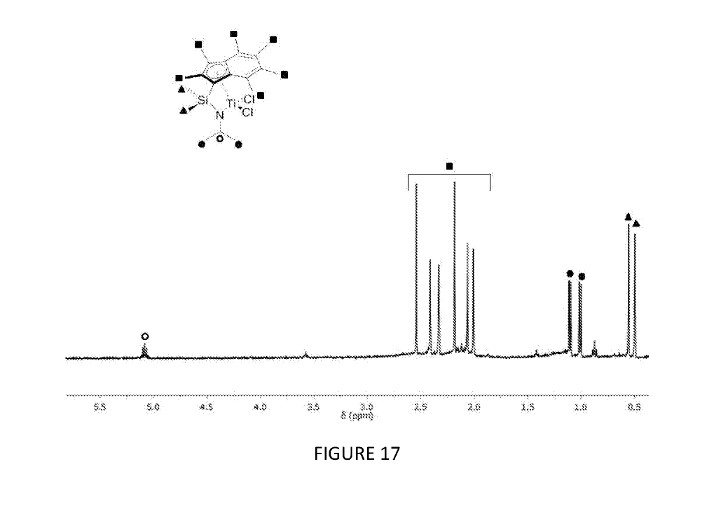

FIG. 17 shows the ¹H NMR spectrum (400 MHz, benzene-d₆, 23° C.) of ^{Me2}SB(^{iPr}N,I*)TiCl₂.

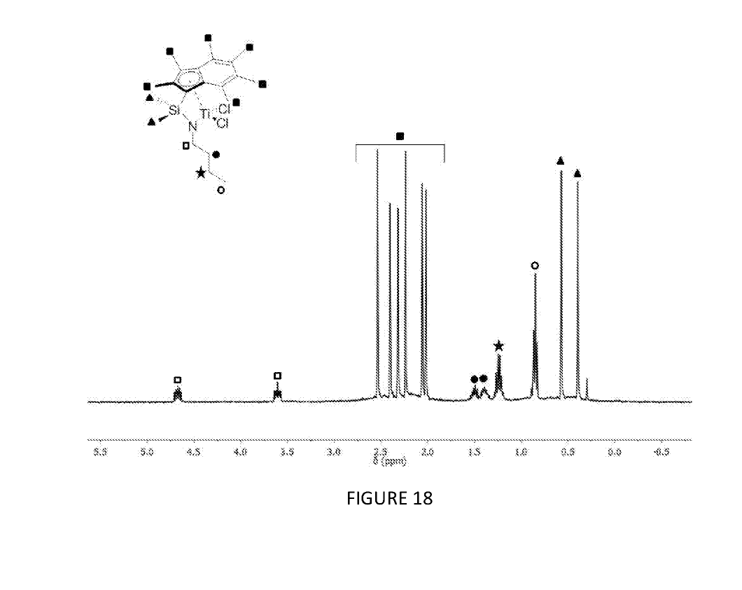

FIG. 18 shows the ¹H NMR spectrum (400 MHz, benzene-d₆, 23° C.) of ^{Me2}SB(^{nBu}N,I*)TiCl₂.

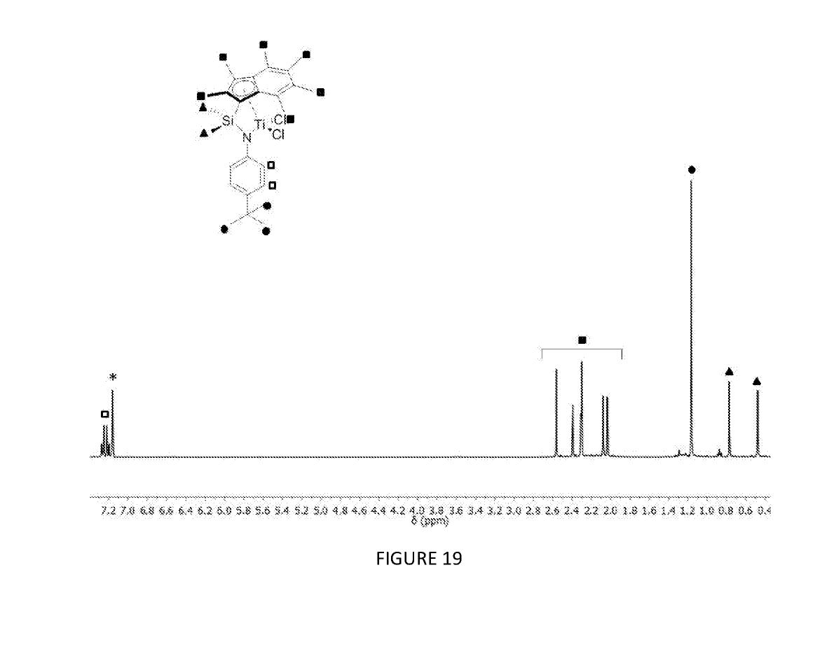

FIG. 19 shows the ¹H NMR spectrum (400 MHz, benzene-d₆, 23° C.) of ^{Me2}SB(^{4tBuPh}N,I*)TiCl₂.

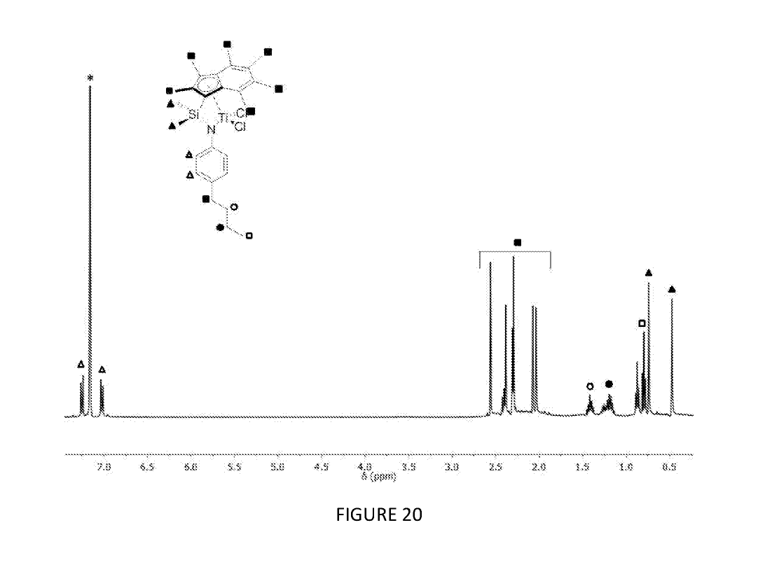

FIG. 20 shows the ¹H NMR spectrum (400 MHz, benzene-d₆, 23° C.) of ^{Me2}SB(^{4nBuPh}N,I*)TiCl₂.

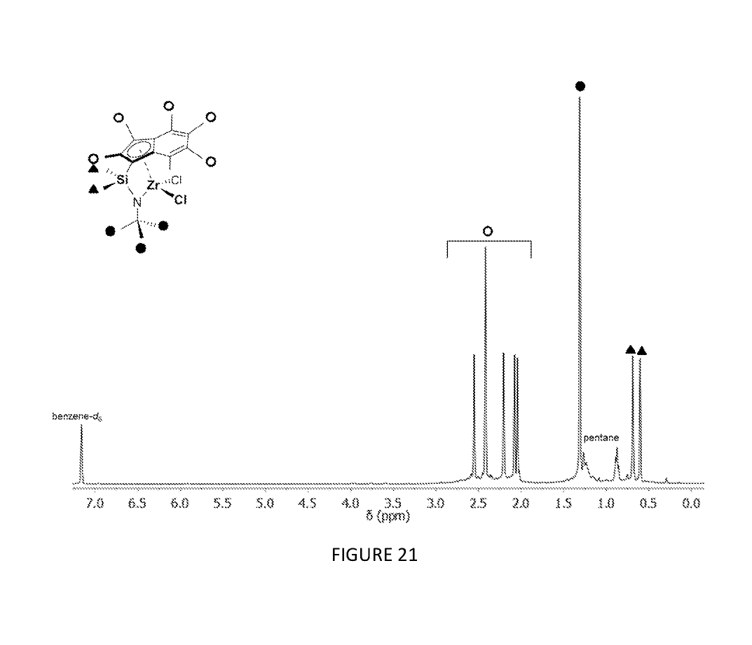

FIG. 21 shows the ¹H NMR spectrum (400 MHz, benzene-d₆, 23° C.) of ^{Me2}SB(^{tBu}N,I*)ZrCl₂.

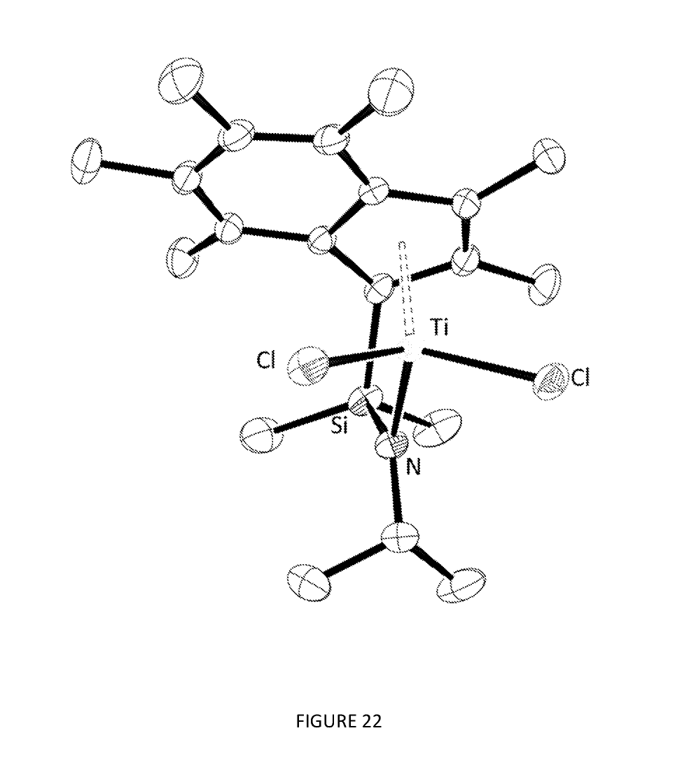

FIG. 22 shows the molecular structure of ^{Me2}SB(^{iPr}N,I*)TiCl₂.

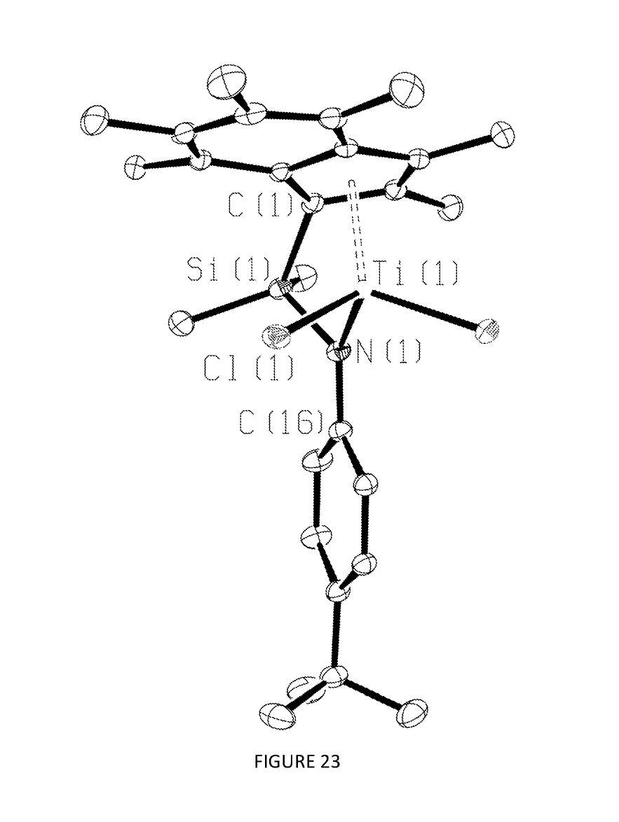

FIG. 23 shows the molecular structure of ^{Me2}SB(^{4tBuPh}N,I*)TiCl₂.

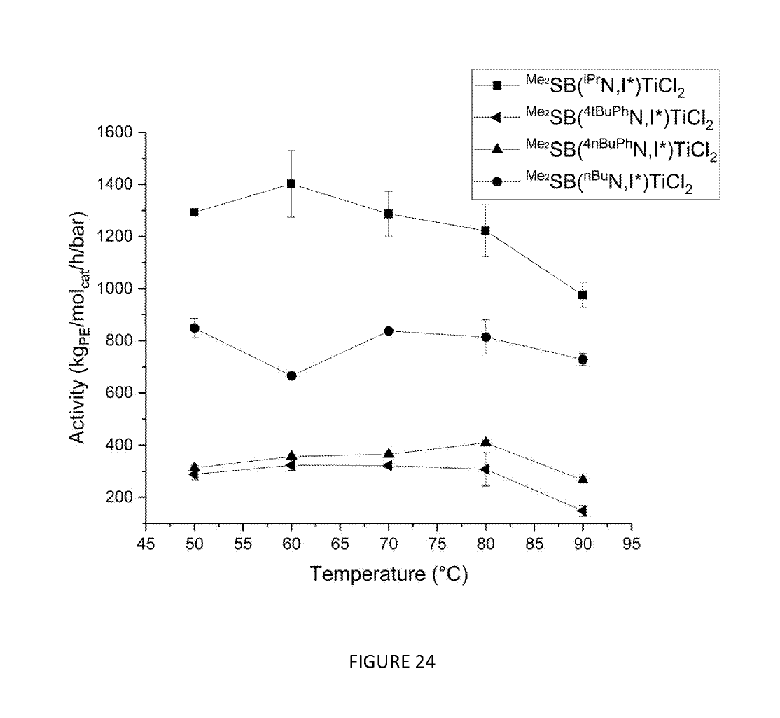

FIG. 24 shows the slurry polymerisation of ethylene over a range of temperature using solid MAO/^{Me2}SB(^{iPr}N,I*)TiCl₂ (black square), solid MAO/^{Me2}SB(^{4tBuPh}N,I*)TiCl₂ (black left triangle), solid MAO/^{Me2}SB(^{4nBuPh}N,I*)TiCl₂ (black triangle) and solid MAO/^{Me2}SB(^{nBu}N,I*)TiCl₂ (black circle). Polymerisation conditions: 2 bar of ethylene, 10 mg of catalyst, 30 minutes, [Al]₀/[Ti]₀=200, 150 mg of TIBA and 50 mL hexanes.

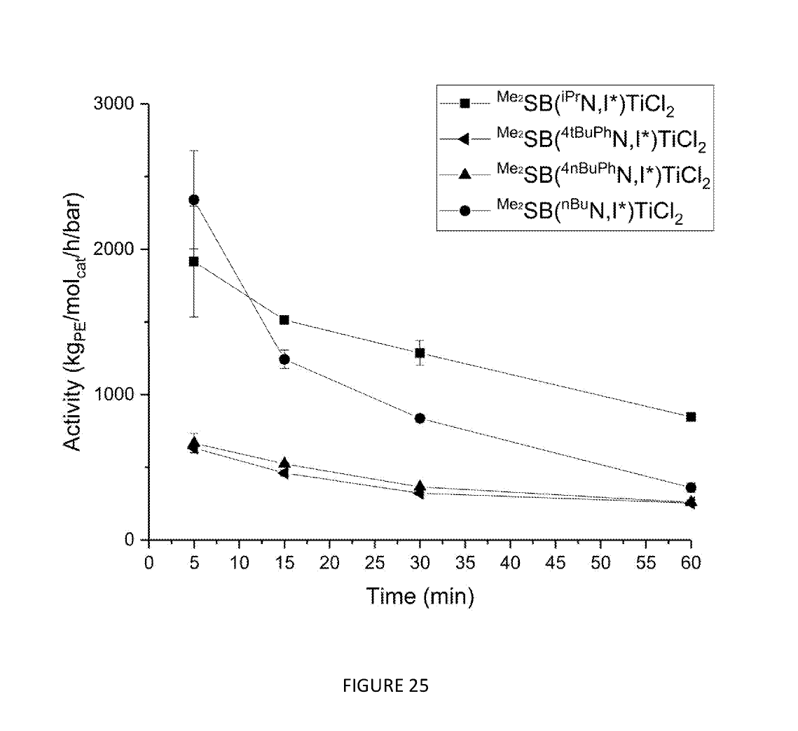

FIG. 25 shows the slurry polymerisation of ethylene of a range of time using solid MAO/^{Me2}SB(^{iPr}N,I*)TiCl₂ (black square), solid MAO/^{Me2}SB(^{4tBuPh}N,I*)TiCl₂ (black left triangle), solid MAO/^{Me2}SB(^{4nBuPh}N,I*)TiCl₂ (black triangle) and solid MAO/^{Me2}SB(^{nBu}N,I*)TiCl₂ (black circle). Polymerisation conditions: 2 bar of ethylene, 10 mg of catalyst, 70° C., [Al]₀/[Ti]₀=200, 150 mg of TIBA and 50 mL hexanes.

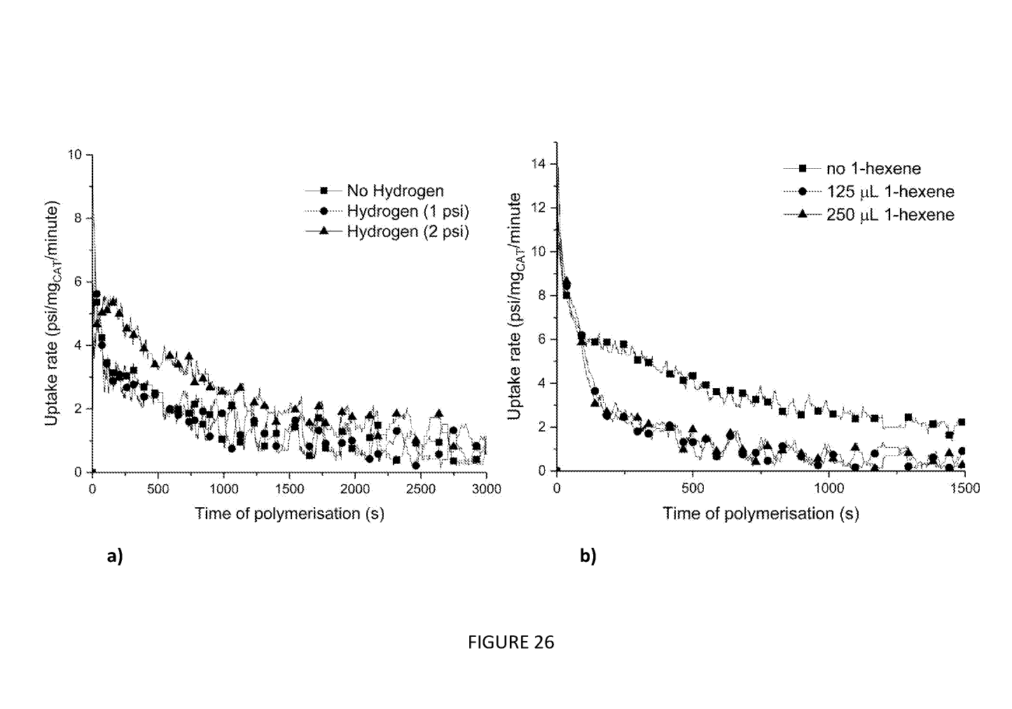

FIG. 26 shows the ethylene uptake rate for the slurry polymerisation of ethylene using solid MAO/^{Me2}SB(^{iPr}N,I*)TiCl₂ for a) hydrogen response: no hydrogen (black square), 1 psi hydrogen (black circle) and 2 psi hydrogen (black triangle) and b) copolymerisation of ethylene and 1-hexene: no 1-hexene (black square), 125 μL 1-hexene (black circle) and 250 μL 1-hexene (black triangle). Polymerisation conditions: 8 bar of ethylene, 0.05 mg of catalyst, 80° C., 10 μmol of TIBA and 5 mL heptane.

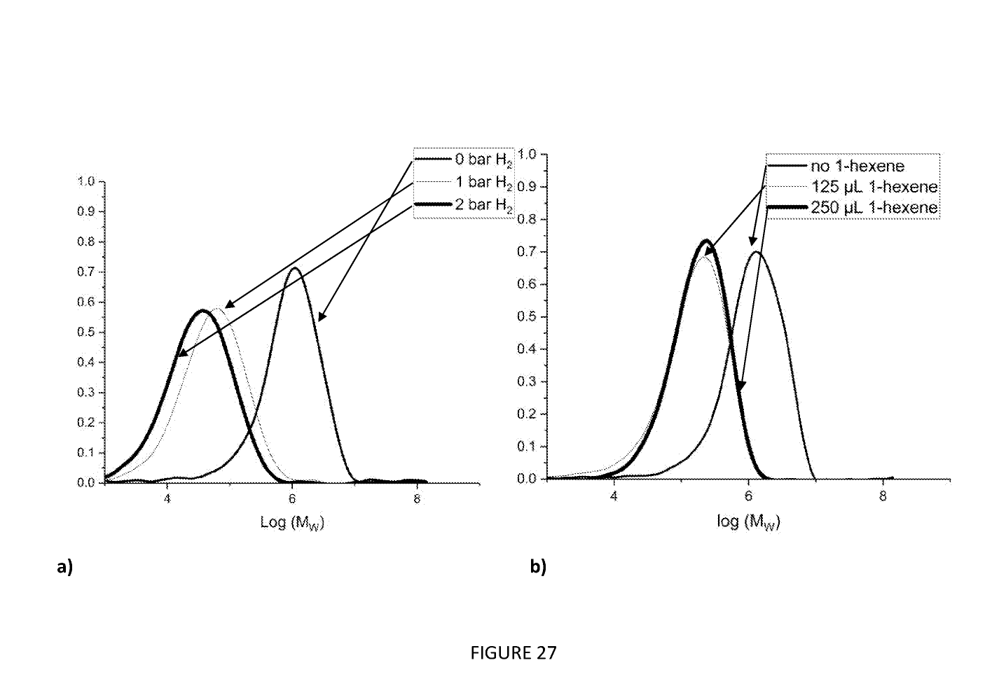

FIG. 27 shows GPC traces for the slurry polymerisation of ethylene using solid MAO/^{Me2}SB(^{tBu}N,I*)TiCl₂ for a) hydrogen response and b) copolymerisation of ethylene and 1-hexene (b)). Polymerisation conditions: 8 bar of ethylene, 0.05 mg of catalyst, 80° C., 10 μmol of TIBA and 5 mL heptane.

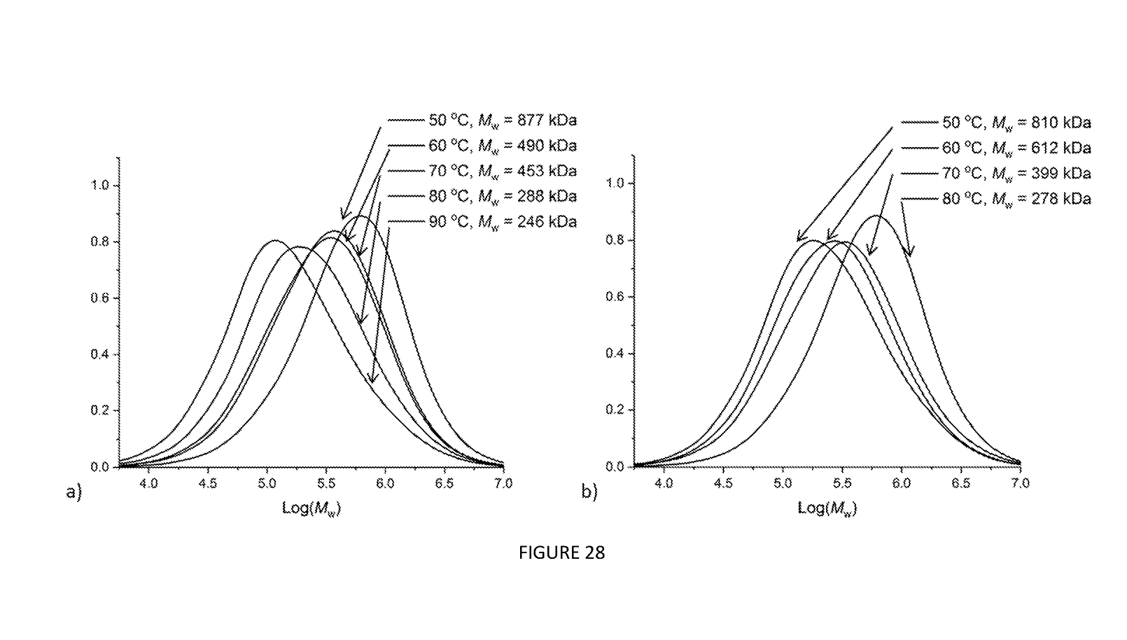

FIG. 28 shows GPC traces of polyethylenes synthesised using a)^{Me}^{₂}SB(^{tBu}N,I*)TiCl₂ and b) ^{Et}^{₂}SB(^{tBu}N,I*)TiCl₂. Polymerisation conditions: 10 mg of catalyst, 50 mL hexanes, 2 bar, 30 minutes, and 150 mg TIBA.

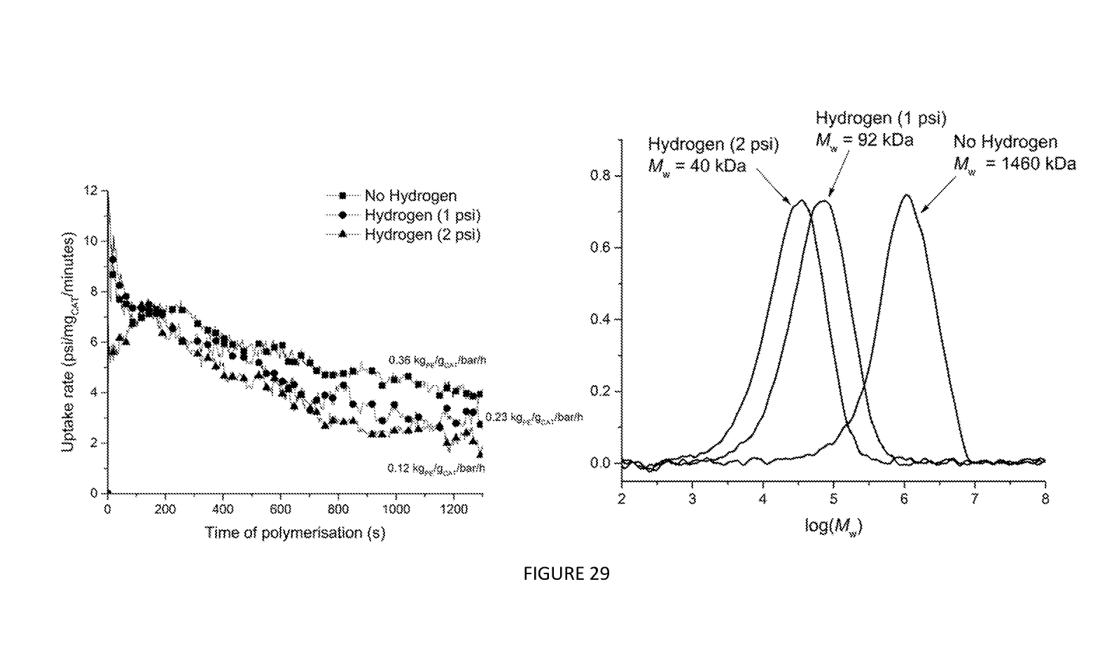

FIG. 29 shows Slurry-phase ethylene polymerisation uptake (left) and GPC traces (right) with solid MAO/^{Et}^{₂}SB(^{tBu}N,I*)TiCl₂ with no hydrogen (black square), 1 psi hydrogen (black circle) and 2 psi hydrogen (black triangle). Polymerisation conditions: 8 bar of ethylene, 0.05 mg of catalyst, 80° C., 10 μmol of TIBA and 5 mL heptane.

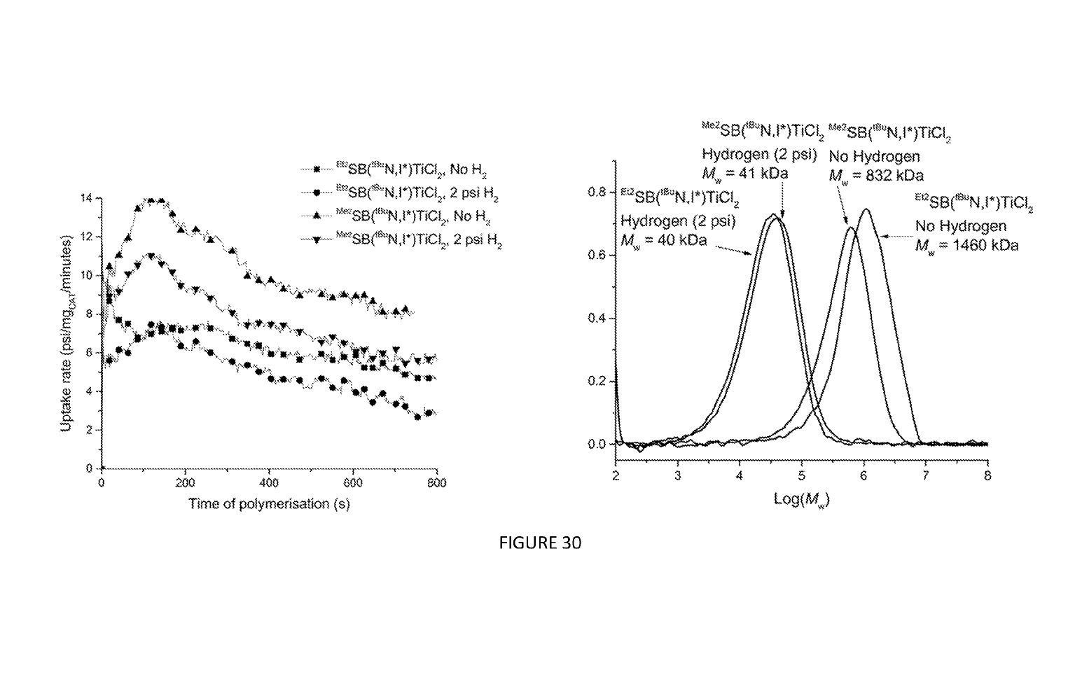

FIG. 30 shows slurry-phase ethylene polymerisation activities (left) and GPC traces (right) with solid MAO/^{Et}^{₂}SB(^{tBu}N,I*)TiCl₂ with no H₂ (black square) and 2 psi H₂ (black circle), and with solid MAO/^{Me}^{₂}SB(^{tBu}N,I*)TiCl₂ with no H₂ (black triangle) and 2 psi H₂ (down triangle). Polymerisation conditions: 8 bar of ethylene, 0.05 mg of catalyst, 80° C., 10 μmol of TIBA and 5 mL heptane.

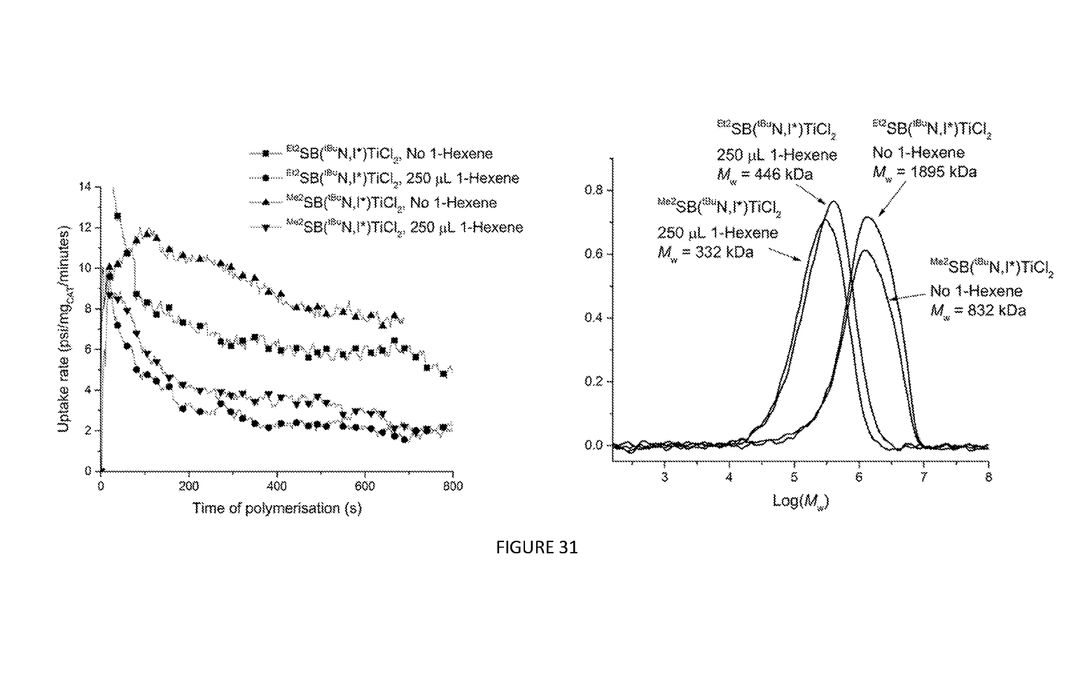

FIG. 31 shows slurry-phase ethylene polymerisation activities (left) and GPC traces (right) with solid MAO/^{Et}^{₂}SB(^{tBu}N,I*)TiCl₂ with no 1-hexene (black square) and 250 μL 1-hexene (black circle), and with solid MAO/^{Me}^{₂}SB(^{tBu}N,I*)TiCl₂ with no 1-hexene (black triangle) and 250 μL 1-hexene (black down triangle). Polymerisation conditions: 8 bar of ethylene, 0.05 mg of catalyst, 80° C., 10 μmol of TIBA and 5 mL heptane.

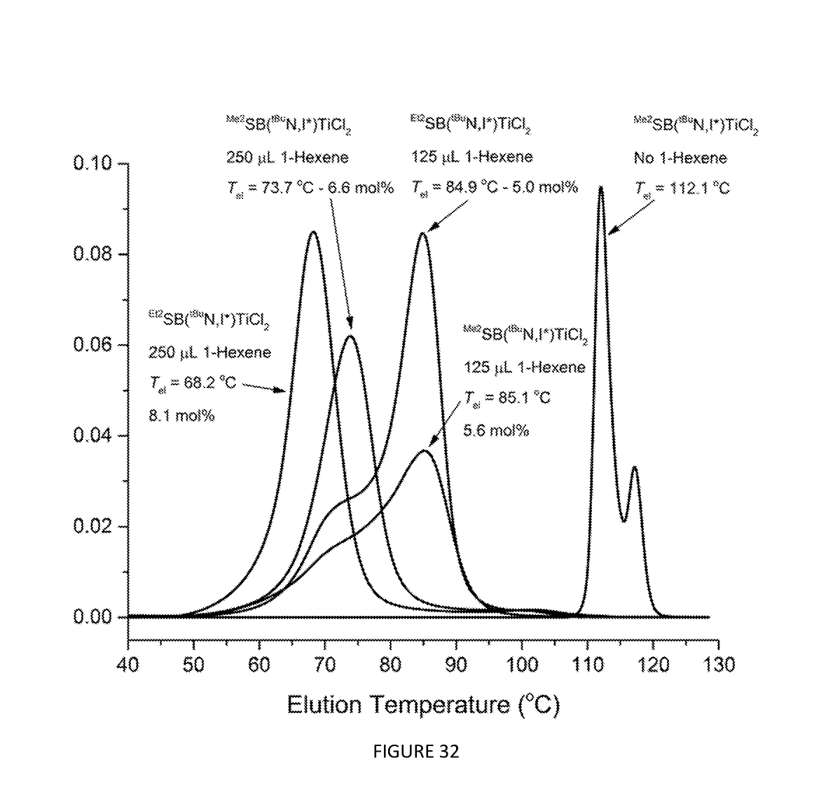

FIG. 32 shows CEF traces with solid MAO/^{Et}^{₂}SB(^{tBu}N,I*)TiCl₂ and solid MAO/^{Me}^{₂}SB(^{tBu}N,I*)TiCl₂. Polymerisation conditions: 8 bar of ethylene, 0.05 mg of catalyst, 80° C., 10 μmol of TIBA and 5 mL heptane.

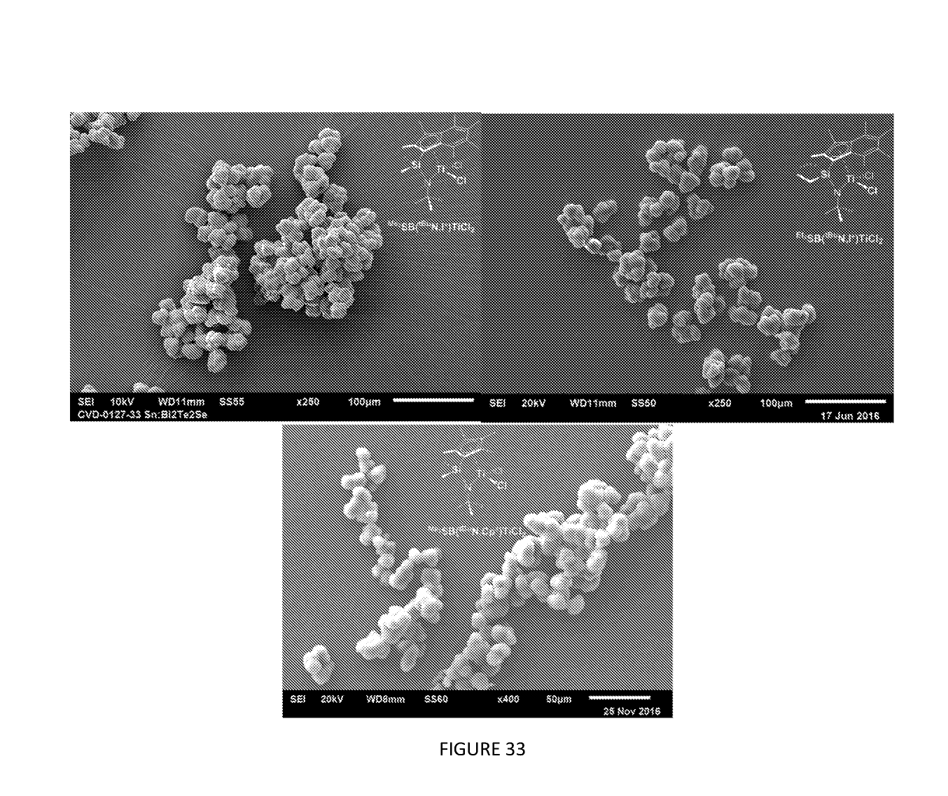

FIG. 33 shows SEM images of the polyethylenes synthesised using solid MAO/^{Et}^{₂}SB(^{tBu}N,I*)TiCl₂, solid MAO/^{Me}^{₂}SB(^{tBu}N,I*)TiCl₂ and solid MAO/^{Me}^{₂}SB(^{tBu}N,Cp*)TiCl₂. Polymerisation conditions: 2 bar of ethylene, 10 mg of catalyst, 70° C., [Al]₀/[Ti]₀=200, 150 mg of TIBA and 50 mL hexanes.

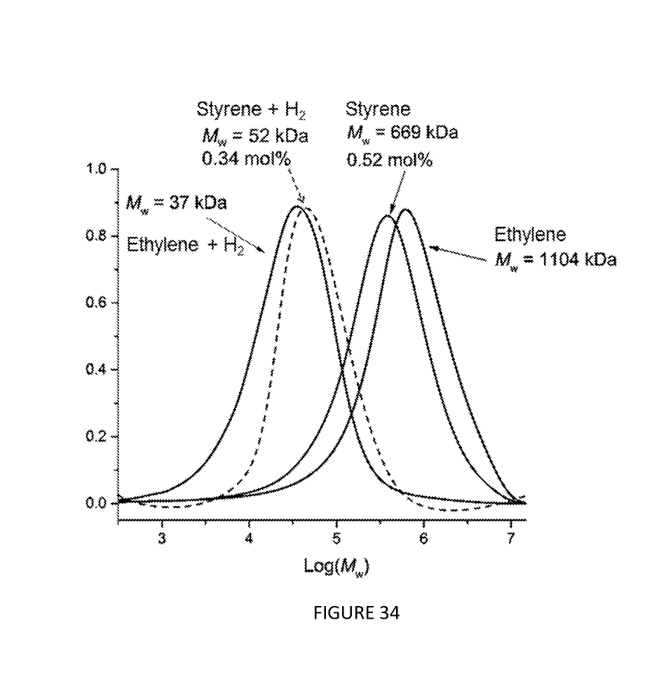

FIG. 34 shows scale up slurry-phase polymerisation using solid MAO/^{Me}^{₂}SB(^{tBu}N,I*)TiCl₂ at various H₂ loading and copolymerisation. Polymerisation conditions: 8 bar of ethylene, 25-50 mg of catalyst, [Al]₀/[Ti]₀=100, 150 mg of TEA and 1000 mL hexanes.

### EXAMPLES

### Example 1—Synthesis of silyl-bridged[(permethylindenyl)(t-butyl amido)titanium dichloride (^{R2}SB(^{tBu}N,I)TiCl₂) CGCs

Having regard to Scheme 1 shown below, ligands useful in the preparation of the ^{R2}SB(^{tBu}N,I*)TiCl₂ CGCs were synthesised by the following procedure: In a large Schlenk, 1 equivalent of greenish oil hexamethylindene (Ind^{#})H (3.0 g, 15.0 mmol) was dissolved in 100 mL pentane to afford a greenish solution. 1.1 equivalent of ⁿBuLi (11.0 mL, 16.4 mmol, 2.5 M in Hexanes) was added dropwise (over 30 minutes) unto the previous solution cooled to 5° C. (ice/water bath). The solution turned slightly yellow/green. The reaction was left stirring at 23° C. for 18 h. After 18 h, the Schlenk contains off-white solid ((Ind^{#})Li) and dark orange solution. The pentane was pumped away to afford off-white solid. THF (30 mL) was added unto the solid to afford a red solution, then this solution was added dropwise (over 15 minutes) unto a previously cooled (to 5° C.) solution of 3.0 equivalent of dichlorodimethylsilane (5.8 g, 5.5 mL, 44.9 mmol) in THF (20 mL) or another dichlorodialkylsilane. The red solution of (Ind^{#})Li instantly decolourised when reacting with the previous solution. After 15 minutes, the yellow solution was stirred for 2 h at 23° C. Then, the THF was dried to afford Ind*SiMe₂Cl as an oil. Finally, 1.1 equivalent of LiNH^{t}Bu (1.3 g, 16.4 mmol) in THF (20 mL) was added at once unto a solution of Ind*SiMe₂Cl in THF (40 mL) cooled at to 5° C. (ice/water bath). The solution was stirred for 18 h, then dried, extracted with 2×20 mL of pentane and finally dried to afford ^{Me}^{₂}Si(^{tBu}N,I)H₂ as an oil in quantitative yield.

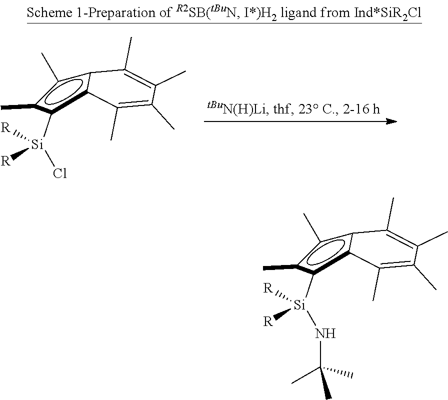

FIGS. 1 and 2 respectively show the ¹H NMR spectra for the ligands ^{Me2}SB(^{tBu}N,I*)H₂ and ^{Me,Propyl}SB(^{tBu}N,I)H₂.

Once the ^{R2}SB(^{tBu}N,I*)H₂ ligand has been prepared, the ^{R2}SB(^{tBu}N,I*)TiCl₂ CGCs were formed according to Scheme 2 shown below by the following procedure: 2.2 equivalents of ⁿBuLi (2.7 mL, 6.7 mmol, 2.5 M in hexanes) was added dropwise, over 5 minutes, unto a solution of 1 equivalent of ^{Me}^{₂}Si(^{tBu}N,I*)H₂ (1 g, 3.0 mmol) in THF (40 mL) cooled to 5° C. The solution quickly turned red. The reaction was stirred for 2 h at 25° C. Then the solvent was dried and the sticky orange solid was washed with 2×50 mL of pentane to afford a yellow solid in quantitative yields. Benzene (40 mL) was added into a Schlenk containing 1 equivalent of ^{Me}^{₂}Si(^{tBu}N,I*)Li₂ (1 g, 2.9 mmol) and 1 equivalent of TiCl₄.THF₂ (978 mg, 2.9 mmol), the solution turned dark red. The reaction was stirred for 17 h at 25° C. Then, the solution was thoroughly dried and the dark red solid was extracted with 2×50 mL pentane. The pentane solution was concentrated to 20 mL and put in −30° C. freezer. A 1^{st} crop of ^{Me}^{₂}Si(^{tBu}N,I*)TiCl₂ was isolated in 26% yield (335 mg), the solution was put back in a −30° C. freezer.

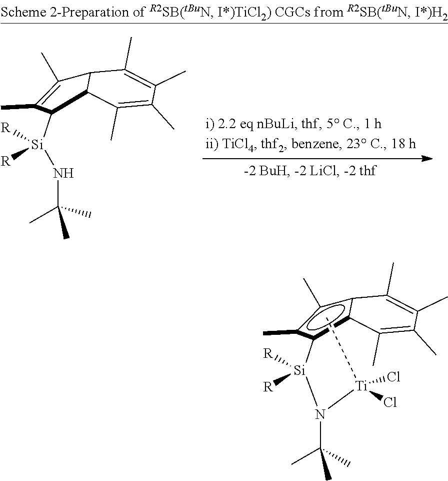

FIGS. 3 and 4 respectively show the ¹H NMR spectra for the CGCs ^{Me2}SB(^{tBu}N,I*)TiCl₂ and ^{Et2}SB(^{tBu}N,I*)TiCl₂. FIG. 5 shows the molecular structure of ^{Me2}SB(^{tBu}N,I*)TiCl₂

### Example 2—Synthesis of Solid Polymethylaluminoxane Catalytic Compositions

The solid polymethylaluminoxane used in this Example may be prepared via an adaptation of the optimised procedure in Kaji et al. in the U.S. Pat. No. 8,404,880 B2 embodiment 1 (Scheme 3). For brevity, each synthesised solid polymethylaluminoxane is represented as solid MAO(Step 1 Al:O ratio/Step 2 temperature in ° C., time in h/Step 3 temperature in ° C., time in h). Hence, the synthesis conditions outlined in Scheme 3 below would yield solid MAO(1.2/70, 32/100, 12).

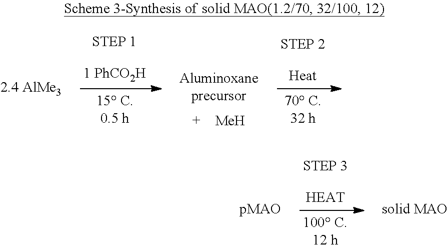

A Rotaflo ampoule containing a solution of trimethyl aluminium (2.139 g, 2.967 mmol) in toluene (8 mL) was cooled to 15° C. with rapid stirring, and benzoic acid (1.509 g, 1.239 mmol) was added under a flush of N₂ over a period of 30 min. Effervescence (presumably methane gas, MeH) was observed and the reaction mixture appeared as a white suspension, which was allowed to warm to room temperature. After 30 min the mixture appeared as a colourless solution and was heated in an oil bath at 70° C. for 32 h (a stir rate of 500 rpm was used). The mixture obtained was a colourless solution free of gelatinous material, which was subsequently heated at 100° C. for 12 h. The reaction mixture was cooled to room temperature and hexane (40 mL) added, resulting in the precipitation of a white solid which was isolated by filtration, washed with hexane (2×40 mL) and dried in vacuo for 3 h. Total yield=1.399 g (71% based on 40 wt % Al).

Having regard to FIG. 6, once the solid polymethylaluminoxane is prepared, different quantities of the ^{Me2}SB(^{tBu}N,I*)TiCl₂ and ^{Et2}SB(^{tBu}N,I*)TiCl₂ CGCs were supported on it (the different quantities being represented by varying aluminium to titanium ratios). In the glovebox, the solid polymethylaluminoxane and the complex are weighed out in a Schlenk tube. Toluene (50 mL) is added to the Schlenk and the reaction mixture swirled at 60° C. for one hour. The coloured solid is allowed to settle from the clear, colourless solution which is decanted, and the solid is dried in vacuo (40° C., 1×10⁻² mbar). The product (solid MAO/^{Me2}SB(^{tBu}N,I*)TiCl₂ and solid MAO/^{Et2}SB(^{tBu}N,I*)TiCl₂) is scraped out in the glovebox in quantitative yield.

Aside from the solid MAO/^{Me2}SB(^{tBu}N,I*)TiCl₂ and solid MAO/^{Et2}SB(^{tBu}N,I*)TiCl₂ compositions of the invention, a comparator composition (solid MAO/^{Me2}SB(^{tBu}N,Cp*)TiCl₂) was prepared by supporting the commercially-available ansa-bridged permethylcyclopentadienyl amido CGC shown below on solid polymethylaluminoxane using the same procedure.

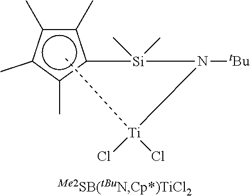

### Example 3—Polymerisation Studies

### Ethylene Homopolymerisation

The catalytic activity of the solid MAO/^{Me2}SB(^{tBu}N,I*)TiCl₂ and solid MAO/^{Et2}SB(^{tBu}N,I*)TiCl₂ compositions of the invention was compared with that of the solid MAO/^{Me2}SB(^{tBu}N,Cp*)TiCl₂ comparator composition in the slurry polymerisation of ethylene. FIG. 7 shows that the solid MAO/^{Me2}SB(^{tBu}N,I*)TiCl₂ and solid MAO/^{Et2}SB(^{tBu}N,I*)TiCl₂ compositions of the invention demonstrated catalytic activities that were on average 4-6 times higher than for the comparator composition solid MAO/^{Me2}SB(^{tBu}N,Cp*)TiCl₂.

FIG. 8 shows an SEM image for a polyethylene synthesised using the solid MAO/^{Me2}SB(^{tBu}N,I*)TiCl₂ composition of the invention. The SEM shows that the polyethylene has generally good morphology

### Addition of Hydrogen/Co-Monomer

Using Solid MAO/^{Me2}SB(^{tBu}N,I)TiCl₂

The solid MAO/^{Me2}SB(^{tBu}N,I*)TiCl₂ compositions of the invention was assessed for its ability to polymerise ethylene in the presence of H2 (as molecular weight modifier) and 1-hexene (as co-monomer).

Table 1 below shows the effect of increasing H2 pressure on the characteristics of polyethylene prepared using the solid MAO/^{Me2}SB(^{tBu}N,I*)TiCl₂ of the invention. Table 2 below shows the effect of increasing 1-hexene content on the characteristics of polyethylene prepared using the solid MAO/^{Me2}SB(^{tBu}N,I*)TiCl₂ of the invention.

TABLE 1
Hydrogen response for the slurry polymerisation of ethylene
using solid MAO/^{Me2}SB(^{tBu}N,I*)TiCl₂. Polymerisation
conditions: 8 bar of ethylene, 0.05 mg of catalyst, 80° C.,
10 μmol of TIBA and 5 mL heptane.

| | | Productivity | | | |
|---|---|---|---|---|---|
| | | (Kg_{PE}/ | M_{w} | | Tₑₗᵤₜᵢₒₙ |
| Catalyst | H₂ | g_{CAT}/h/bar) | (kDa) | M_{w}/Mₙ | (° C.) |
| Solid | 0 | 0.51 | 832 | 2.9 | 112.1 |
| MAO/^{Me2}SB(^{tBu}N,I*)TiCl₂ | | | | | |
| Solid | 1 | 0.40 | 80 | 2.4 | 111.3 |
| MAO/^{Me2}SB(^{tBu}N,I*)TiCl₂ | | | | | |
| Solid | 2 | 0.34 | 41 | 2.9 | 110.9 |
| MAO/^{Me2}SB(^{tBu}N,I*)TiCl₂ | | | | | |

TABLE 2
Slurry co-polymerisation of ethylene and 1-hexene using solid
MAO/^{Me2}SB(^{tBu}N,I*)TiCl₂. Polymerisation conditions: 8 bar of ethylene,
0.05 mg of catalyst, 80° C., 10 μmol of TIBA and 5 mL heptane.

| | | | | | | 1-hexene |
|---|---|---|---|---|---|---|
| | | Productivity | M_{w} | M_{w}/ | Tₑₗᵤₜᵢₒₙ | incorporation |
| Catalyst | V₁₋ₕₑₓₑₙₑ | (Kg_{PE}/g_{CAT}/h/bar) | (kDa) | Mₙ | (° C.) | (mol %) |
| Solid | 0 | 0.47 | 2667 | 3.2 | Not | — |
| MAO/^{Me2}SB(^{tBu}N,I*)TiCl₂ | | | | | eluted | |
| Solid | 125 | 0.37 | 269 | 3.0 | 85.1 | 5.6 |
| MAO/^{Me2}SB(^{tBu}N,I*)TiCl₂ | | | | | | |
| Solid | 250 | 0.25 | 332 | 2.5 | 73.7 | 6.6 |
| MAO/^{Me2}SB(^{tBu}N,I*)TiCl₂ | | | | | | |

FIG. 9a shows the ethylene uptake rate during ethylene polymerisation using solid MAO/^{Me2}SB(^{tBu}N,I*)TiCl₂ as a function of increasing H₂ pressure. FIG. 9b shows the ethylene uptake rate during ethylene-hexene copolymerisation using solid MAO/^{Me2}SB(^{tBu}N,I*)TiCl₂ as a function of increasing hexane content. FIG. 10a shows GPC traces for ethylene polymerised using solid MAO/^{Me2}SB(^{tBu}N,I*)TiCl₂ under different H₂ pressures. FIG. 10b shows GPC traces for ethylene polymerised using solid MAO/^{Me2}SB(^{tBu}N,I*)TiCl₂ with varying 1-hexene co-monomer content.

Table 1 and FIG. 9a show that despite a small decrease, solid MAO/^{Me2}SB(^{tBu}N,I*)TiCl₂ continues to be extremely active in ethylene polymerisation even under 2 psi of hydrogen. FIG. 9b right shows that solid MAO/^{Me2}SB(^{tBu}N,I*)TiCl₂ is an extremely good incorporator of 1-hexene, using all the co-monomers very rapidly.

Table 1 and FIG. 10a shows very high molecular weight for the initial homopolymerisation, and a decrease in molecular weight with increasing hydrogen. Table 2 and FIG. 10b shows very high molecular weight for the initial homopolymerisation with similar M_{w} for the copolymerisation.

Solid MAO/^{Me2}SB(^{tBu}N,I*)TiCl₂ vs. Solid MAO/^{Me2}SB(^{tBu}N,Cp*)TiCl₂

The catalytic performance of the solid MAO/^{Me2}SB(^{tBu}N,I*)TiCl₂ composition of the invention was compared with that of the solid MAO/^{Me2}SB(^{tBu}N,Cp*)TiCl comparator composition in a variety of different ethylene polymerisation conditions.

FIG. 11 shows the productivity of polymerisation for various polymerisation conditions (homopolymerisation of ethylene; addition of hydrogen in homopolymerisation of ethylene; copolymerisation of ethylene and 1-hexene; and copolymerisation of ethylene with styrene) using solid MAO/^{Me2}SB(^{tBu}N,I*)TiCl₂ (black column) and solid MAO/^{Me2}SB(^{tBu}N,Cp*)TiCl₂ (white column). The results show that in all polymerisation conditions, the solid MAO/^{Me2}SB(^{tBu}N,I*)TiCl₂ composition of the invention afforded higher productivities than the solid MAO/^{Me2}SB(^{tBu}N,Cp*)TiCl₂ comparator composition.

FIG. 12 and Table 3 below compares the catalytic performance of the solid MAO/^{Me2}SB(^{tBu}N,I*)TiCl₂ composition of the invention and the solid MAO/^{Me2}SB(^{tBu}N,Cp*)TiCl comparator composition in when ethylene is polymerised with and without hydrogen.

TABLE 3
Productivity of ethylene homopolymerisation with and without
hydrogen using Solid MAO/^{Me2}SB(^{tBu}N,I*)TiCl₂ and Solid
MAO/^{Me2}SB(^{tBu}N,Cp*)TiCl₂ in slurry phase polymerisation

| | Amount | | | | | | |
|---|---|---|---|---|---|---|---|
| | of | | | | | | |
| | catalyst | P | Ratio | % | T | Time | Productivity |
| Catalyst | (mg) | (bar) | H₂:C₂ | H₂ | (° C.) | (minutes) | (kg_{PE}/g_{CAT}/h) |
| Solid MAO/ | 25 | 8 | 0 | 0 | 80 | 60 | 2.22 |
| ^{Me2}SB(^{tBu}N,I*)TiCl₂ | | | | | | | |
| Solid MAO/ | 50 | 8 | 0 | 0 | 80 | 60 | 2.38 |
| ^{Me2}SB(^{tBu}N,I*)TiCl₂ | | | | | | | |
| Solid MAO/ | 50 | 8 | 0.0057 | 50 | 80 | 50 | 1.82 |
| ^{Me2}SB(^{tBu}N,I*)TiCl₂ | | | | | | | |
| Solid MAO/ | 100 | 8 | 0.0115 | 100 | 80 | 56 | 1.61 |
| ^{Me2}SB(^{tBu}N,I*)TiCl₂ | | | | | | | |
| Solid MAO/ | 25 | 8 | 0 | 0 | 80 | 60 | 1.03 |
| ^{Me2}SB(^{tBu}N,Cp*)TiCl₂ | | | | | | | |
| Solid MAO/ | 50 | 8 | 0.0057 | 50 | 80 | 120 | 0.41 |
| ^{Me2}SB(^{tBu}N,Cp*)TiCl₂ | | | | | | | |

Table 3 and FIG. 12 demonstrate that an increase in hydrogen feed results, as expected, in a decrease in productivities for both catalysts. However, importantly, when the results for solid MAO/^{Me2}SB(^{tBu}N,I*)TiCl₂ and solid MAO/^{Me2}SB(^{tBu}N,Cp*)TiCl₂ were directly compared, the solid MAO/^{Me2}SB(^{tBu}N,I*)TiCl₂ composition of the invention afforded significantly higher productivities than those observed with the solid MAO/^{Me2}SB(^{tBu}N,Cp*)TiCl₂ comparator composition.

### Example 4—Synthesis of dimethylsilyl-bridged[(permethylindenyl)(R amido)titanium dichloride (^{Me2}SB(^{R}N,I*)TiCl₂) CGCs

With regard to Scheme 3 shown below, ligands useful in the preparation of the ^{Me2}SB(^{R}N,I*)TiCl₂ GCGs were synthesised by the following procedure: In a large Schlenk, 1 equivalent of greenish oil hexamethylindene (Ind^{#})H (3.0 g, 15.0 mmol) was dissolved in 100 mL pentane to afford a greenish solution. 1.1 equivalent of ⁿBuLi (11.0 mL, 16.4 mmol, 2.5 M in hexanes) was added dropwise (over 30 minutes) unto the previous solution cooled to 5° C. (ice/water bath). The solution turned slightly yellow/green. The reaction was left stirring at 23° C. for 18 h. After 18 h, the Schlenk contains off-white solid ((Ind^{#})Li) and dark orange solution. The pentane was pumped away to afford off-white solid. THF (30 mL) was added unto the solid to afford a red solution, then this solution was added dropwise (over 15 minutes) unto a previously cooled (to 5° C.) solution of 3.0 equivalent of dichlorodimethylsilane (5.8 g, 5.5 mL, 44.9 mmol) in THF (20 mL). The red solution of (Ind^{#})Li instantly decolourised when reacting with the previous solution. After 15 minutes, the yellow solution was stirred for 2 h at 23° C. Then, the THF was dried to afford Ind*SiMe₂CI as an oil. 1 equivalent of RNHLi (R=ⁱPr (0.21 g), ⁿBu (0.27 g), 4-^{t}BuPh (0.50 g), and 4-ⁿBuPh (0.50 g)) and Ind*SiMe₂Cl (1.00 g, 3.40 mmol) were dissolved in THF (50 mL) cooled to 5° C. (ice/water bath). The solution was stirred for 2 h at 23° C., then dried, and the product extracted in 2×20 mL of pentane and dried to yield ^{Me2}SB(^{R}N,I*)H₂ as an oil in a quantitative yield.

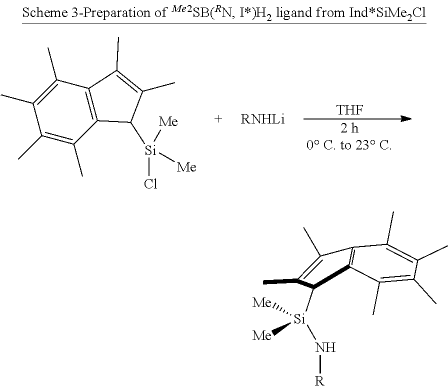

FIGS. 13, 14, 15 and 16 respectively show the ¹H NMR spectra for the ligands ^{Me2}SB(^{iPr}N,I*)H₂, ^{Me2}SB(^{nBu}N,I*)H₂, ^{Me2}SB(^{tBuPh}N,I*)H₂ and ^{Me2}SB(^{nBuPH}N,I*)H₂.

Following the preparation of the proligand ^{Me2}SB(^{R}N,I*)H₂, the ^{Me2}SB(^{R}N,I*)TiCl₂ CGC was synthesised according to the procedure shown in Scheme 4: 2.2 equivalents of ⁿBuLi (3.0 mL, 6.7 mmol, 2.5 M in hexanes) was added dropwise to a solution of ^{Me2}SB(^{R}N,I*)H₂ in 30 mL of THF cooled to 5° C. (water/ice bath). The solution darkened from yellow to orange and the reaction mixture was stirred for 30 minutes at 23° C. The reaction mixture was then dried under vacuum, and the solid product was washed with pentane (2×25 mL) and dried to yield a yellow solid ^{Me2}SB(^{R}N,I*)Li₂. 40 mL of benzene was added to a Schlenk containing 1 equivalent of ^{Me2}SB(^{R}N,I*)Li₂ (R=iPr (0.35 g, 1.07 mmol), nBu (0.56 g, 1.65 mmol), 4-tBuPh (1.00 g, 2.40 mmol), 4-nBuPh (1.00 g, 2.40 mmol)) and 1 equivalent of TiCl₄.2THF (0.36 g, 0.55 g, 0.80 g, 0.80 g respectively). The solution turned a dark red and was stirred for 23 h. The reaction mixture was then dried under vacuum, and the product was extracted in pentane. The pentane solution was placed in a 30° C. freezer and a red solid was afforded in all cases. ^{Me2}SB(^{iPr}N,I*)TiCl₂ was isolated in a 5.3% yield (79 mg), ^{Me2}SB(^{nBu}N,I*)TiCl₂ in a 6.5% yield (102 mg), ^{Me2}SB(^{4-tBuPh}N,I*)TiCl₂ in a 28% yield (360 mg), and ^{Me2}SB(^{4-nBuPh}N,I*)TiCl₂ in a 21% yield (280 mg).

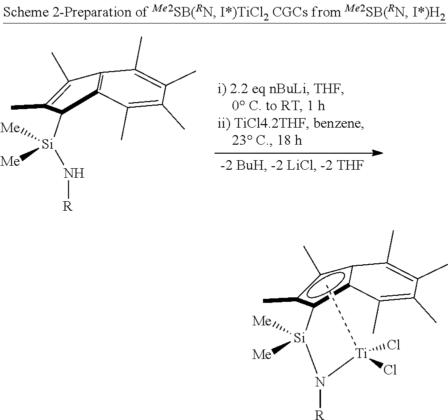

FIGS. 17, 18, 19, 20, and 21 respectively show the ¹H NMR spectra for the CGCs ^{Me2}SB(^{iPr}N,I*)TiCl₂, ^{Me2}SB(^{nBu}N,I*)TiCl₂, ^{Me2}SB(^{tBuPh}N,I*)TiCl₂, ^{Me2}SB(^{nBuPh}N,I*)TiCl₂ and ^{Me2}SB(^{tBu}N,I*)ZrCl₂. FIGS. 22 and 23 respectively show the molecular structures of ^{Me2}SB(^{iPr}N,I*)TiCl₂ and ^{Me2}SB(^{tBuPh}N,I*)TiCl₂.

### Example 5—Synthesis of Solid Polymethylaluminoxane Catalytic Compositions

The CGCs prepared in Example 4 were supported on solid polymethylaluminoxane according to the protocol discussed in Example 2. The resulting compositions (solid MAO/^{Me2}SB(^{iPr}N,I*)TiCl₂, solid MAO/^{Me2}SB(^{tBuPh}N,I*)TiCl₂, solid MAO/^{Me2}SB(^{nBu}N,I*)TiCl₂ and solid MAO/^{Me2}SB(^{nBuPh}N,I*)TiCl₂) were then taken forward for further polymerisation studies.

### Example 6—Further Polymerisation Studies

### Ethylene Homopolymerisation

The catalytic activity of the solid MAO/^{Me2}SB(^{R}N,I*)TiCl₂ compositions of the invention prepared in Example 5 were compared in the slurry phase polymerisation of ethylene. FIGS. 25 and 26 (demonstrating temperature and time dependence on polymerisation activity) demonstrate that all of the solid MAO/CGC compositions of the invention show ethylene polymerisation activity, with aniline-based CGC compositions tending to have a lower activity than aliphatic CGC compositions.

### Addition of Hydrogen/Co-Monomer

The effect of hydrogen addition on the ability of solid MAO/^{Me2}SB(^{iPr}N,I*)TiCl₂ to polymerise ethylene was investigated. The results are outlined in Table 4 below, and in FIG. 26a.

TABLE 4
Hydrogen response for the slurry polymerisation of ethylene
using solid MAO/^{Me2}SB(^{iPr}N,I*)TiCl₂. Polymerisation
conditions: 8 bar of ethylene, 0.05 mg of catalyst,
80° C., 10 μmol of TIBA and 5 mL heptane

| | | Productivity | M_{w} | |
|---|---|---|---|---|
| Catalyst | H₂ | (Kg_{PE}/g_{CAT}/h/bar) | (kDa) | M_{w}/Mₙ |
| Solid MAO/^{Me2}SB(^{iPr}N,I*)TiCl₂ | 0 | 0.09 | 1442 | 2.4 |
| Solid MAO/^{Me2}SB(^{iPr}N,I*)TiCl₂ | 1 | 0.07 | 93 | 3.2 |
| Solid MAO/^{Me2}SB(^{iPr}N,I*)TiCl₂ | 2 | 0.07 | 58 | 3.6 |

The effect of comonomer addition (1-hexene) on the ability of solid MAO/^{Me2}SB(^{iPr}N,I*)TiCl₂ to polymerise ethylene was investigated. The results are outlined in Table 5 below, and in FIG. 26b.

TABLE 5
Slurry co-polymerisation of ethylene and 1-hexene using solid
MAO/^{Me2}SB(^{iPr}N,I*)TiCl₂. Polymerisation
conditions: 8 bar of ethylene, 0.05 mg of catalyst, 80° C.,
10 μmol of TIBA and 5 mL heptane

| | | Productivity | | | |
|---|---|---|---|---|---|
| | | (Kg_{PE}/ | M_{w} | M_{w}/ | Tₑₗᵤₜᵢₒₙ |
| Catalyst | V₁₋ₕₑₓₑₙₑ | g_{CAT}/h/bar) | (kDa) | Mₙ | (° C.) |
| Solid | 0 | 0.08 | 1650 | 2.6 | 113.9 |
| MAO/ | | | | | |
| ^{Me2}SB(^{iPr}N,I*)TiCl₂ | | | | | |
| Solid | 125 | 0.03 | 286 | 3.3 | 98.8 |
| MAO/ | | | | | |
| ^{Me2}SB(^{iPr}N,I*)TiCl₂ | | | | | |
| Solid | 250 | 0.02 | 218 | 2.3 | 80.5 |
| MAO/ | | | | | |
| ^{Me2}SB(^{iPr}N,I*)TiCl₂ | | | | | |

The effect of hydrogen/comonomer addition on the ability of other compositions of the invention to polymerise ethylene was investigated. FIG. 28 shows that solid MAO/^{Me2}SB(^{tBu}N,I*)TiCl₂ and solid MAO/^{Et}^{₂}SB(^{tBu}N,I*)TiCl₂) gave ultra-high molecular weight polyethylenes at 50° C. (M_{w} above 800 kDa) and moderate molecular weight polyethylenes at 80° C. (M_{w} around 280 kDa). FIG. 29 shows solid MAO/^{Et}^{₂}SB(^{tBu}N,I*)TiCl₂ demonstrated good response towards hydrogen (activity >0.36 kg_{PE}/g_{CAT}/h) at 2 psi H₂, with relatively high molecular weights (M_{w}=40 kDa). Solid MAO/^{Me2}SB(^{tBu}N,I*)TiCl₂ and solid MAO/^{Et2}SB(^{tBu}N,I*)TiCl₂ show very high activities followed by quick deactivation with increasing 1-hexene addition (FIG. 32). The CEF demonstrated very high incorporation of the comonomer (FIG. 33).

While specific embodiments of the invention have been described herein for the purpose of reference and illustration, various modifications will be apparent to a person skilled in the art without departing from the scope of the invention as defined by the appended claims.

1. A catalytic composition comprising a compound of formula (I) shown below associated with solid polymethylaluminoxane: 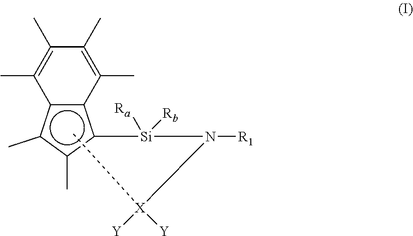
wherein
R₁ is (1-6C)alkyl, —Si(R₂)₃ or phenyl, either of which is optionally substituted with one or more groups selected from (1-4C)alkyl;
wherein each R₂ is independently selected from (1-3C)alkyl;
Rₐ and R_{b} are independently hydrogen, (1-6C)alkyl, aryl and aryl(1-2C)alkyl, either or which may be optionally substituted with one or groups selected from (1-2C)alkyl;
X is scandium, yttrium, lutetium titanium, zirconium or hafnium
each Y is independently halo, hydrogen, a phosphonated, sulfonated or borate anion, or a (1-6C)alkyl, (2-6C)alkenyl, (2-6C)alkynyl, (1-6C)alkoxy, aryl or aryloxy group which is optionally substituted with one or more groups selected from (1-6C)alkyl, halo, nitro, amino, phenyl, (1-6C)alkoxy, —C(O)NRₓR_{y} or Si[(1-4C)alkyl]₃;
wherein Rₓ and R_{y} are independently (1-4C)alkyl.

2. The composition of claim 1, wherein R₁ is (1-5C)alkyl, —Si(R₂)₃ or phenyl, either of which is optionally substituted with one or more groups selected from (1-3C)alkyl, wherein each R₂ is independently selected from (1-4C)alkyl.

3. The composition of claim 1 or 2, wherein R₁ is (1-5C)alkyl, —Si(R₂)₃ or phenyl, either of which is optionally substituted with one or more groups selected from (1-3C)alkyl, wherein each R₂ is independently selected from (1-2C)alkyl.

4. The composition of claim 1, wherein R₁ is (2-5C)alkyl or phenyl, either of which is optionally substituted with one or more (e.g. 2 or 3) groups selected from (1-4C)alkyl.

5. The composition of claim 1, wherein R₁ is methyl, ethyl, iso-propyl, iso-butyl, n-butyl, sec-butyl, tert-butyl, neopentyl, trimethylsilyl, phenyl, mesityl, xylyl, di-isopropylphenyl, tert-butylphenyl or n-butylphenyl.

6.-9. (canceled)

10. The composition of claim 1, wherein Rₐ and R_{b} are independently selected from hydrogen, (1-4C)alkyl and phenyl.

11. (canceled)

12. (canceled)

13. The composition of claim 1, wherein X is titanium, zirconium or hafnium.

14. (canceled)

15. (canceled)

16. The composition of claim 1, wherein each Y is independently halo, hydrogen, or a (1-4C)alkyl group which is optionally substituted with one or more groups selected from (1-4C)alkyl, halo, nitro, amino, phenyl and (1-4C)alkoxy.

17. The composition of claim 1, wherein each Y is independently halo, hydrogen, or a (1-4C)alkyl group which is optionally substituted with one or more groups selected from (1-4C)alkyl, halo and phenyl.

18.-21. (canceled)

22. The composition of claim 1, wherein the compound of formula (I) has a structure according to formula (Ia) below: 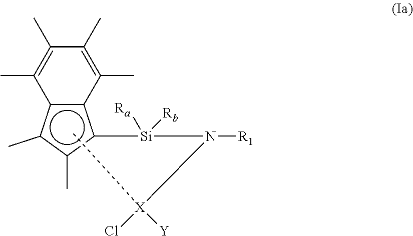
wherein Rₐ, R_{b}, X, Y and R₁ each have any of the definitions appearing in any preceding claim.

23. The composition of claim 22, wherein Y is chloro.

24. The composition of claim 1, wherein the compound of formula (I) has a structure according to formula (Ia) shown below: 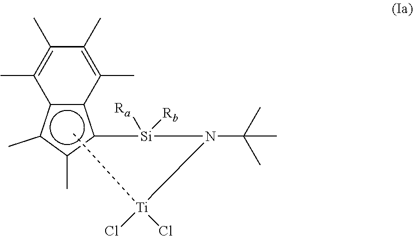
wherein
Rₐ and R_{b} are independently (1-3C)alkyl.

25. The composition of claim 1, wherein the compound of formula (I) has any of the following structures:

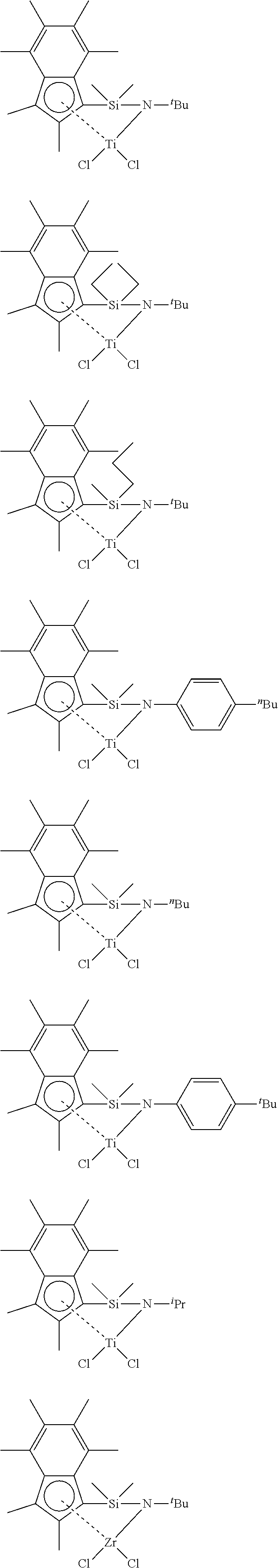

26. The composition of claim 1, wherein the solid polymethylaluminoxane is prepared by heating a solution comprising methylaluminoxane and a hydrocarbon solvent (e.g. toluene).

27. The composition of claim 1, wherein the solubility in n-hexane at 25° C. of the solid polymethylaluminoxane is 0-2 mol %.

28. The composition of claim 1, wherein the solubility in toluene at 25° C. of the solid polymethylaluminoxane is 0-2 mol %.

29. The composition of claim 1, wherein the solid polymethylaluminoxane has an aluminium content in the range of 36-41 wt %.

30.-33. (canceled)

34. A polymerisation process comprising the step of:
a) polymerising ethylene and optionally one or more (3-10C)alkene in the presence of a composition as defined in claim 1.

35. The process of claim 34, wherein step a) comprises polymerising ethylene and optionally one or more (3-10C)alkene in the presence of hydrogen.

36. The process of claim 34, wherein the one or more (3-10C)alkene is styrene or 1-hexene or styrene.

37. (canceled)
